(19) United States
(12) Patent Application Publication
(10) Pub. No.: US 2026/0132525 A1
(43) Pub. Date: May 14, 2026

(54) APPARATUS FOR FORMATION OF AMMONIA USING DIVERSE NITROGEN BASED FEEDSTOCKS

(71) Applicant: COLORADO STATE UNIVERSITY RESEARCH FOUNDATION, Fort Collins, CO (US)

(72) Inventor: Mohammadreza Nazemi, Fort Collins, CO (US)

(73) Assignee: COLORADO STATE UNIVERSITY RESEARCH FOUNDATION, Fort Collins, CO (US)

(21) Appl. No.: 19/442,884

(22) Filed: Jan. 7, 2026

Related U.S. Application Data
(63) Continuation of application No. PCT/US2024/037099, filed on Jul. 8, 2024.
(60) Provisional application No. 63/525,650, filed on Jul. 7, 2023.

(51) Int. Cl. C25B 11/089; B01D 15/08; B01D 53/047; C25B 1/27; C25B 9/19; C25B 9/23; C25B 9/77; C25B 11/091; C25B 15/08

(52) U.S. Cl. CPC C25B 11/089; B01D 15/08; B01D 53/047; C25B 9/19; C25B 9/23; C25B 9/77; C25B 11/091; C25B 15/085; B01D 2253/102; B01D 2256/10; C25B 1/27

(57) ABSTRACT

An apparatus for producing ammonia in an electrochemical system, from a nitrogen-containing species, a proton source, a catalyst, and electricity, without the heat and pressure traditionally used in the industry to produce ammonia, wherein the catalyst comprises at least two transition metals.

### CROSS REFERENCE TO RELATED APPLICATIONS

This application is a continuation of PCT/US2024/037099, filed Jul. 8, 2024, which claims the benefit of U.S. provisional patent application No. 63/525,650, filed Jul. 7, 2023, the entire content of which applications is incorporated by reference for all that it discloses and teaches.

### FIELD

The present disclosure is directed to an apparatus for producing ammonia in an electrochemical system, from a nitrogen-containing species, a proton source, a catalyst, and electricity, without the heat and pressure traditionally used in the industry to produce ammonia.

### BACKGROUND

Ammonia (NH₃) is an important chemical source of nitrogen in various industries including applications in fertilizer components, pharmaceuticals, and other sectors. Ammonia also provides a renewable energy carrier with high density energy and carbon-free characteristics. Current industrial processes to produce ammonia are very energy-demanding processes that leave a significant carbon footprint worldwide.

Traditionally, ammonia is produced through Haber-Bosch thermochemical processes at extreme pressures and temperatures, which contributes to global energy consumption as well as energy related CO₂ emissions.

In the United States, ammonia is used primarily as a fertilizer or as a feedstock in producing fertilizers (e.g., urea, nitrate). Nitrogenous fertilizer comprises about 40% of the United States fertilizer industry and mixed fertilizers account for another 25%. This equates to approximately $7.3 billion in the ammonia market.

Therefore, there exists a need for producing ammonia using electrocatalysts with high activity, selectivity, and stability for efficient NH₃ production at an industrial scale.

### BRIEF SUMMARY

Disclosed herein is an apparatus for making ammonia in an electrochemical system, from a nitrogen-containing species (e.g., nitrate from the fertilizer runoff), a proton source (water vapor or hydrogen), an in-house catalyst, and renewable electricity without the heat and pressure traditionally used by industry to make these chemicals. The nitrogen-containing species is combined with water on the catalyst cathode and electrolyzed in the absence of added heat and pressurization. In one embodiment, the temperature ranges for 10-100 degrees C. In one embodiment, the temperature ranges for 15-85 degrees C. In one embodiment, the pressure ranges for 1-10 bar. In one embodiment, the pressure ranges for 1-5 bar. In one embodiment, the catalyst comprises at least two transition metals and combinations thereof. In one embodiment, the transition metals include but are not limited to Cu, Ru, Ir, Co, Ni, Pd, Ag, Pt, Zn, W, Mo, S and combinations thereof. In one embodiment, the catalyst comprises CuₓRu_{y}. In one embodiment, the CuₓRu_{y} is selected from the group consisting of Cu₁₀₀Ru₁, Cu₁₀Ru₁, Cu₁Ru₁, Cu₁Ru₁₀, and Cu₁Ru₁₀₀. In one embodiment, the electricity is applied through pulse electrolysis.

In one embodiment, the nitrogen-containing species is selected from the group consisting of fertilizer run off, feedstock from air, wastewater, exhaust gas and combinations thereof. In one embodiment, the concentration of nitrogen in the nitrogen-containing species is in the range of 0.0001 to 0.5M. In another embodiment, the concentration of nitrogen is selected from the group consisting of 0.01 to 0.5M; 0.001 to 0.9M; 0.001 to 0.5M and 0.01 to 0.9M.

In one embodiment, the catalyst is selected from at least two transition metals and combinations thereof. In one embodiment, the two transition metals comprise CuₓRu_{y}. In one embodiment, the CuₓRu_{y} is selected from the group consisting of Cu₁₀₀Ru₁, Cu₁₀Ru₁, Cu₁Ru₁, Cu₁Ru₁₀, Cu₁Ru₁₀₀ and combinations thereof.

In one embodiment, the proton source is selected from the group consisting of water, hydrogen, organic solvents including, but not limited, to methanol, ethanol, acetone and combinations thereof. In one embodiment, the electricity comprises renewable electricity, including but not limited to wind energy and solar energy. In one embodiment, pulse electrolysis is applied. In one embodiment, potentiostatic electrolysis is applied. In one embodiment, the Faradaic efficiency is at least 50% FE_{NH3}. In one embodiment, the Faradaic efficiency is at least 70% FE_{NH3}. In one embodiment, the Faradaic efficiency is at least 90% FE_{NH3}. In one embodiment, the Faradaic efficiency is at least 95% FE_{NH3}. In one embodiment, the Faradaic efficiency is at least 99% FE_{NH3}.

In one embodiment, the density is at least 200 mA cm⁻². In one embodiment, the density is at least 500 mA cm⁻². In one embodiment, the density is at least 1000 mA cm⁻². In one embodiment, the density is at least 5000 mA cm⁻². In one embodiment, the NH₃ yield rate is above 4 mmol h⁻¹ cm⁻². In one embodiment, the NH₃ yield rate is above 4.5 mmol h⁻¹ cm⁻². In one embodiment, the NH₃ yield rate is above 5 mmol h⁻¹ cm⁻². In one embodiment, the NH₃ yield rate is above 5.74 mmol h⁻¹ cm⁻². In one embodiment, the NH₃ yield rate is above 6 mmol h⁻¹ cm⁻². In one embodiment, the stability exceeds 50 hours. In one embodiment, the stability exceeds 75 hours. In one embodiment, the stability exceeds 100 hours.

In one embodiment, the system as illustrated in FIG. 22A wherein electrolysis of NOₓ+H₂ produces NH₃ gas and collection of liquid ammonia. The system can accommodate both liquid and gaseous feedstocks and any sources of nitrogen-based compounds. In one embodiment, ammonia is synthesized using a nitrogen-based compound from nitrogen-based feeder stock via an electrochemical nitrogen reduction reaction in the presence of a catalyst material, wherein the catalyst comprises at least two transition metals. In one embodiment, a yield of the nitrogen-based compound is at least 0.87 μg cm⁻²h⁻¹. In one embodiment, a Faradaic efficiency of the nitrogen-based compound is at least 50%. In one embodiment, a Faradaic efficiency of the nitrogen-based compound is at least 75%. In one embodiment, a Faradaic efficiency of the nitrogen-based compound is at least 90%. In one embodiment, the catalyst comprises CuₓRu_{y} In one embodiment, the CuₓRu_{y} is selected from the group consisting of Cu₁₀₀Ru₁, Cu₁₀Ru₁, Cu₁Ru₁, Cu₁Ru₁₀, and Cu₁Ru₁₀₀.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows a free energy diagram for nitrogen oxidation and reduction states, in acidic and basic solutions.

FIG. 2 shows the X-ray powder diffraction (XRD) spectra of CuₓRu_{y} catalysts.

FIGS. 3A-D show the energy dispersive X-ray (EDX) elemental mapping analysis Cu₁Ru₁₀ catalyst. The scale bar in the left image applies to all images. FIG. 3A shows High-resolution Energy Dispersive X-ray spectroscopy elemental mapping analysis Cu₁Ru₁₀ catalyst. FIG. 3B shows Carbon (green). FIG. 3C shows Copper (blue). FIG. 3D shows Ru (red).

FIG. 4 shows the X-ray photoelectron spectroscopy (XPS) survey spectra of Cu₁Ru₁₀ catalysts.

FIGS. 5A-B show the XPS spectra of Cu₁Ru₁₀. FIG. 5A shows the XPS spectra of C 1s and Ru3d. FIG. 5B shows the XPS spectra O 1s of Cu₁Ru₁₀.

FIGS. 6A-E show the chronoamperometry curves for CuₓRu_{y} catalysts at different potentials for 60 min in 0.1 M KOH with 0.5 M NO₃⁻. FIG. 6A shows the chronoamperometry curve for Cu₁₀₀Ru₁. FIG. 6B shows the chronoamperometry curve for Cu₁₀Ru₁. FIG. 6C shows the chronoamperometry curve for Cu₁Ru₁. FIG. 6D shows the chronoamperometry curve for Cu₁Ru₁₀. FIG. 6E shows the chronoamperometry curve for Cu₁Ru₁₀₀.

FIG. 7 shows a cyclic voltammogram (CV) for the determination of the double-layer capacitance of CuRu-4 in Ar-saturated 0.1 M KOH and 0.5 M KNO₃.

FIG. 8 shows LSV curves of Cu₁Ru₁₀ catalysts in various NO₃⁻ in 0.1 M KOH.

FIGS. 9A-D show the chronoamperometry i-t curves for Cu₁Ru₁₀ catalysts at different potentials for 60 min in different NO₃⁻ concentrations. FIG. 9A shows the chronoamperometry i-t curve at 0.2 M NO₃⁻. FIG. 9B shows the chronoamperometry i-t curve at 0.1 M NO₃⁻. FIG. 9C shows the chronoamperometry i-t curve at 0.05 M NO₃⁻. FIG. 9D shows the chronoamperometry i-t curve at 0.01 NO₃⁻.

FIG. 10 shows a comparison of yield rate of NH₃ for Cu₁Ru₁₀ measured in different NO₃⁻ concentrations at potentials of −0.4 V vs. RHE.

FIGS. 11A-D show the catalytic performance comparison of Cu₁Ru₁₀ catalysts and corresponding Faradaic efficiencies of its NO3RR products measured in different NO₃⁻ concentrations. FIG. 11A shows the performance and efficiency at 0.2 M NO₃⁻. FIG. 11B shows performance and efficiency at 0.1 M. FIG. 11C shows the performance and efficiency at 0.05 M NO₃⁻. FIG. 11D shows the performance and efficiency at 0.01 M NO₃⁻.

FIGS. 12A-F show V-t and i-t curves of pulsed NO3RR at applied pulsed conditions of Ea=+0.6 V, Ec=−0.2 VI. FIG. 12A shows cathodic time tc=4.5 s and anodic time ta=0.5 and 1 s. FIG. 12B shows cathodic time tc=4.5 s and anodic time ta=0.5 and 1 s.

FIG. 12C shows cathodic time tc=7.5 s and anodic time ta=0.5 and 1 s. FIG. 12D shows cathodic time tc=7.5 s and anodic time ta=0.5 and 1 s. FIG. 12E shows cathodic time tc=9.5 s and anodic time ta=0.5 and 1 s. FIG. 12F shows cathodic time tc=9.5 s and anodic time ta=0.5 and 1 s.

FIGS. 13A-F show V-t and i-t curves of pulsed NO3RR at applied pulsed conditions of Ea=+0.4 V and Ec=−0.2 VI. FIG. 13A shows cathodic time tc=4.5 s and anodic time ta=0.5 and 1 s. FIG. 13B shows cathodic time tc=4.5 s and anodic time ta=0.5 and 1 s.

FIG. 13C shows cathodic time tc=7.5 s and anodic time ta=0.5 and 1 s. FIG. 13D shows cathodic time tc=7.5 s and anodic time ta=0.5 and 1 s. FIG. 13E shows cathodic time tc=9.5 s and anodic time ta=0.5 and 1 s. FIG. 13F shows cathodic time tc=9.5 s and anodic time ta=0.5 and 1 s.

FIGS. 14A-B show NO3RR performance of Cu₁Ru₁₀ catalysts under pulsed condition in a 0.01 M NO₃⁻. FIG. 14A shows FE_{NH3} yield rate with an applied pulsed condition of Eₐ=+0.4 V, Ec=−0.2 V, tc=1.5 to 9.5 s, ta=0.2 to 1 s. FIG. 14B shows NH₃ yield rate with an applied pulsed condition of Eₐ=+0.4 V, Ec=−0.2 V, tc=1.5 to 9.5 s, ta=0.2 to 1 s.

FIG. 15 shows turnover frequency (TOF) comparison of MEA-AEM and MEA-BPM at different current densities

FIGS. 16A-B shows a comparison of full cell NH₃ energy efficiency in H-cell, MEA-AEM and MEA-BPM by applying constant current densities. FIG. 16A shows the efficiency at −120 to −20 J (mA cm⁻²). FIG. 16B shows the efficiency at −30 to −5 J (mA cm⁻²).

FIGS. 17A-D show various images of the catalysts. FIG. 17A shows a transmission electron microscopy image of Cu₁Ru₁₀. FIG. 17B shows a high resolution transmission electron microscopy image of Cu₁Ru₁₀. FIG. 17C shows a high resolution Ru 3p XPS spectra. FIG. 17D shows a high resolution Cu 2p XPS spectra.

FIGS. 18A-F show performance of various CuₓRu_{y} electrocatalysts for NO3RR to produce NH₃. Figure A shows a j-E curve over CuₓRu_{y} in 0.1M KOH solution containing 0.5 M NO₃⁻ (solid lines) or in the absence of NO₃⁻ (dotted line) at a scan rate of 5 mV s₋₁. FIG. 18B shows FE_{NH3} curves as a function of applied potentials. FIG. 18C shows the NH₃ yield rate at various potentials. FIG. 18D shows the FE_{NH3} of Cu₁Ru₁₀ at various potentials measured in different NO₃⁻ concentrations. FIG. 18E shows half-cell energy efficiencies of NH₃ (EE_{NH3}) on Cu₁Ru₁₀ in 0.01 and 0.5 M NO₃⁻ at various applied potentials. FIG. 18F shows consecutive recycling test of Cu₁Ru₁₀ at −0.4 V vs. RHE. Error bars represent standard deviations from three repeated measurements.

FIGS. 19A-B show NO3RR performance of Cu₁Ru₁₀ catalysts under pulsed condition in a 0.01 M NO₃⁻. FIG. 19A shows % FE_{NH3} with an applied pulsed condition of Eₐ=+0.6 V, Ec=−0.2 V, tc=1.5 to 9.5 s, ta=0.2 to 1 s. FIG. 19B shows NH₃ yield rate with an applied pulsed condition of Eₐ=+0.6 V, Ec=−0.2 V, tc=1.5 to 9.5 s, ta=0.2 to 1 s.

FIGS. 20A-C show NO3RR performance of Cu₁Ru₁₀ measured using MEA cell using AEM and BPM membranes. FIG. 20A shows a comparison of FE_{NH3} and NH₃ yield rate at different current densities in 0.1 M KOH+0.5 M NO₃⁻ in AEM and BPM. FIG. 20B shows a comparison of FE_{NH3} and NH₃ yield rate at different current densities in 0.1 M KOH+0.01 M NO₃⁻ in AEM and BPM. FIG. 20C shows a chronoamperometric i-t curve for a duration of 100 h in 1 M KOH containing 0.5 M NO₃⁻ using AEM.

FIGS. 21A-D show diagrams of electrolysis pathways under various conditions. FIG. 21A shows the electrolysis pathway for nitrogen feedstock from air. FIG. 21B shows the electrolysis pathways for nitrogen monoxide, nitrogen dioxide, dinitrogen tetroxide, and nitrous oxide feedstocks from exhaust gas. FIG. 21C shows the electrolysis pathways for nitrous oxide from wastewater. FIG. 21D shows the electrolysis pathways for nitrite and nitrate feedstocks from wastewater.

FIGS. 22A-B show schematic reactor designs. FIG. 22A shows a design for electrolysis of NOₓ+H₂ to produce NH₃ gas and collection of liquid ammonia. FIG. 22B shows a schematic of the electrolyzer unit and its components for nitrogen-based compound transformation to ammonia. Water or water vapor is oxidized to oxygen gas and H⁺ at the anode. If hydrogen gas is used for the anodic reaction, H⁺ is the only product. The cathodic reaction involves reducing nitrogen compounds to ammonia.

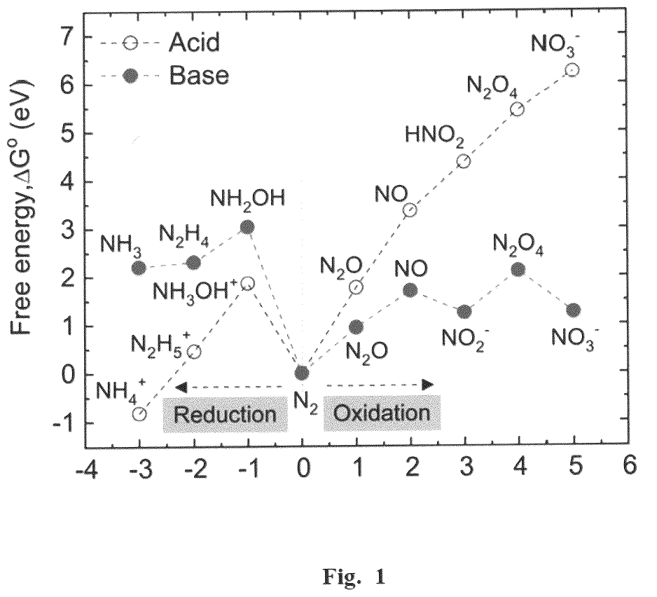

### DEFINITIONS

As used herein, the abbreviation MEA refers to a membrane-electrode assembly.

As used herein, the abbreviation GDL refers to gas diffusion layers.

As used herein, the abbreviation HER refers to the hydrogen evolution reaction 2 H⁺+2 e⁻≥H₂.

As used herein, the abbreviation HOR refers to the hydrogen oxidation reaction (HOR) (H₂(g)→2H⁺+2e⁻, E⁰_{RHE}=0 V).

As used herein, the abbreviation UV-VIS refers to absorption spectroscopy or reflectance spectroscopy in part of the ultraviolet and the full, adjacent visible regions of the electromagnetic spectrum.

As used herein, the abbreviation EDX refers to energy dispersive X-ray spectroscopy.

As used herein, the abbreviation HAADF refers to high-angle annular dark-field imaging.

As used herein, the term “operando” refers to a measurement being performed under ongoing operating conditions.

As used herein, the term “galvanic replacement” refers to oxidation and dissolution of atoms from a substrate, while the salt precursor to another material with a higher reduction potential is reduced and deposited on the substrate. In this technique, the sacrificial metal template with a higher oxidation potential is replaced with the nanocage metal. By replacing metal atoms from the template, a hollow structure is created with holes at the wall and corners of the nanocages.

As used herein, the term pulsed electrolysis refers to an electrochemical system that is subjected to an electrical input (potential or current) of high amplitude and certain frequency.

### DETAILED DESCRIPTION OF THE EMBODIMENTS

An apparatus is described for the production of ammonia by incorporating selective and stable catalyst materials at the nanoscale or sub-nanoscale scale, into electrochemical, modular reactors, which operate at near ambient pressure and temperature, and have flexible operations to follow the renewable supply, and ultimately cost less than the conventional thermos-catalytic methods.

As described herein, a green and sustainable approach to generating nitrogenous fertilizers, including NH₃, significantly reduces carbon emissions and energy demands within the chemical industry. These solutions result in cost savings, especially for rural regions in the United States and developing countries where fertilizers are underused for crop production. In addition, development for the interconversion of N₂ and active nitrogen-based compounds (e.g., NOₓ, NH₃), enables a circular nitrogen economy, mitigating waste and increasing food production.

Electrochemical nitrate reduction (NO3RR) is described as one method of producing NH₃ that circumvents the challenges of the energy-intensive, CO₂ emitting Haber-Bosch process. NO3RR also presents a dual-purpose use, by addressing nitrate removal from the atmosphere, while also generating valuable NH₃.

Efficient reduction using NO3RR to produce NH₃ is significantly hampered by a complex eight-electron and nine-proton reduction process (NO₃+6H₂O+8e⁻→NH₃+9OH, E⁰=0.69 V) with multiple intermediates, resulting in a variety of biproducts (e.g., NO₂, NO₂⁻, NO, N₂O, N₂, and NH₂OH).

Additionally, slow kinetics of the NO3RR process require large overpotentials, promoting the competitive hydrogen evolution reaction (HER). Consequently, this diminishes the Faradaic efficiency (FE) of NH₃, leading to an unsatisfactory energy efficiency (EE) for the NO3RR. Products of NO3RR depend significantly on the cathode material; Cu-based catalysts have activity and selectivity in producing NH₃. Challenges have emerged due to the significant adsorption of partially reduced nitrite (NO₂⁻) intermediates and the inadequate *H supply over Cu, which have been identified as limiting factors for the hydrogenation of NO₂⁻ intermediates, especially at lower overpotentials.

The present disclosure teaches incorporating a metal species capable of H₂ activation throughout the NO₂⁻ reduction process. Metallic Ruthenium (Ru), proficient in the hydrogen evolution reaction (HER) under alkaline conditions, enhances the generation of hydrogen radicals, thereby accelerating the hydrogenation of NO₃⁻ reduction products towards the formation of NH₃.

The presence of Ru sites enhances the adsorption/desorption and activation of the crucial intermediate (i.e., NO₂⁻) in the reaction, thereby aiding the conversion of NO₂⁻ into NH₃. Combining Ru with Cu modulates the electronic structure of the CuRu alloy catalyst and alters adsorption configurations to stabilize reaction intermediates, and creates a synergistic effect, promoting the performance of NO3RR through efficient conversion of NO₃⁻ to NO₂⁻ and rapid hydrogenation of NO₂⁻ to NH₃.

Disclosed herein is an apparatus for making ammonia in an electrochemical system, from a nitrogen-containing species (e.g., nitrate from the fertilizer runoff), a proton source (water vapor or hydrogen), an in-house catalyst, and renewable electricity without the heat and pressure traditionally used by industry to make these chemicals, according to the equations 1 and 2:

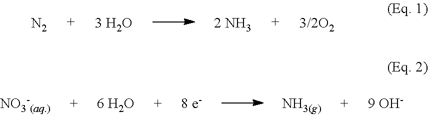

Further disclosed herein is a method for making and using Cu and Ru alloy catalysts, with varying Cu/Ru ratios, to facilitate NO3RR.

Further disclosed herein is a method of using transition metal alloy catalysts to facilitate NO3RR. Transition metals may be selected from the group consisting of Cu, Ru, Co, Fe and Ni.

In a liquid-phase system, N₂ reacts with protons in an aqueous electrolyte to produce ammonia. In the gas-phase system, ammonia is synthesized where gas-phase N₂ and H₂ are reacted at the cathode and anode in an electrochemical system. Ammonia electrosynthesis in the gas-phase setup using porous bimetallic Pd—Ag nanoparticles is described. Pure gaseous ammonia can be collected at the cathode outlet using an acidic absorber (H₂SO₄ (aq.), pH=3). An electrochemical cell with low ohmic resistance is used to improve energy efficiency. The energy efficiency of the electrochemical NRR is improved by utilizing a gas-phase electrochemical cell consisting of a membrane-electrode assembly (MEA) and gas diffusion layers (GDLs). By decreasing the distance between the cathode and the anode and eliminating the liquid electrolyte, MEAs reduce the ohmic losses in the electrochemical cell. Pure H₂ is fed into the anode, where the hydrogen oxidation reaction (HOR) (H₂ (g)→2H⁺+2e⁻, E⁰_{RHE}=0 V) occurs on the Pt-based nanoparticles. Because HER is a competing reaction with the NRR at the cathode, H₂ gas from this reaction can be recovered and fed to the anode, improving the system's energy efficiency. The HOR overpotential is lower than that of oxygen evolution reaction (OER) on Pt-based catalysts, which results in decreasing the applied potentials to drive the anodic reactions. The highest energy efficiency achieved is 72.0% (range of 60-75%) at a total applied potential of <0.5 V (range of 0.1 to 0.7V), which is equivalent to an energy input of 7.7 MWh per ton of ammonia, comparable with the state-of-the-art Haber-Bosch process that uses 7.8 MWh per ton of ammonia (based on the natural gas as a feedstock). The system is demonstrated at the current density of <10 mA cm⁻² (range of 0.1-15 mA cm⁻²).

Multiple reactors are developed and operated in tandem to increase the output capacity. The photocurrent response is substantially increased by manipulating the atomic distribution of a co-catalyst (Pd) on a plasmonic antenna (Au nanorods) via the femtosecond pulsed laser, resulting in 10-35% improvements in decreasing applied voltage. In one embodiment, resulting in 20-25% improvement.

Combining GDL and the flow field in a single component (i.e., transparent end plate) allows the transmission (>95%) of the incident light through the endplate to reach the catalyst, therefore lowering the potential requirements to drive redox reactions and improving the energy efficiency with respect to the externally applied potential. In one embodiment, >90%; in one embodiment, >97%.

Further disclosed herein is the use of renewable energy as an energy source.

Further disclosed herein is the use of non-renewable energy as an energy source.

The versatility of the disclosure enables the use of diverse nitrogen-based compounds in both liquid-phase (nitrate from fertilizer runoff streams) and gas-phase (N₂ or NOₓ) as a feed to generate NH₃. In one embodiment, the method incorporates “green fertilizer production” and evaluates various pathways towards more sustainable agricultural practices worldwide.

Operando surface-enhanced Raman spectroscopy (SERS) is used by combining spectroscopy and electrochemistry to gain insights into the solid-liquid interaction at the electrode-electrolyte interface. A potential is applied on a SERS active substrate, which is then monitored by changes in the Raman spectrum. The prepared nanoparticles are deposited on the working electrode and used as an electrocatalyst. Cyclic voltammetry (CV) measurements are conducted at the specific potential range in Ar- and N₂-saturated electrolytes to track redox reactions.

The formation of hydrazine (N₂H₄) as an intermediate species during electrochemical NRR for ammonia synthesis is identified. Operando SERS measurements help understand the reaction mechanisms allowing the design of more active and selective catalysts in (photo)electrocatalysis. The technology produces ammonia at 7.7 MWh/ton _{NH3} (using renewable energy).

In one embodiment, the system is decentralized and used close to the point of product use. The disclosure teaches a decrease in the input of electrical energy down to 3.0-6.5 MWh per ton of ammonia using various nitrogen sources (N₂, NO₃, NO₂, NO), while increasing the production capacity to 100-150 metric tons annually.

The ammonia is generated with an energy input that is 20-40% below the energy input of the state-of-the-art thermochemical process with zero CO₂ emission (see Table 1). Downsizing the previously demonstrated hybrid Pd—Ag nanoparticles to single-atom alloys decreases the use of noble metal catalysts and capital costs, while improving the conversion process selectivity and the catalyst materials' stability under harsh reaction conditions.

The apparatus enhances the selectivity (e.g., Faradaic efficiency) for ammonia synthesis to greater than 90%, using at least two different nitrogen sources. 100-150 kg ammonia per day (range of 20-250) is produced for distributed fertilizer production and energy storage (50 tons of ammonia per year; range of 25-200 tons). A footprint of 6 m³ meets the annual demand for nitrogenous fertilizer for a farm (e.g., corn farm) with approximately a 1000-acre size. With such a capacity, about 390,000 reactors can meet the United States annual ammonia demand.

The pure oxygen generated in electrolysis systems is captured and the value of pure O₂ in TEA and LCA analyses is considered. Alternative oxidation reactions at the anode, such as nitrogen oxidation reaction (NOR) are used, to lower the total voltage requirement to drive redox reactions by a minimum of 17% (range of 15-25%).

A method is described employing the galvanic replacement process to synthesize hollow metallic nanoparticles (NPs) of various shapes and sizes, mainly bimetallic NPs made of Pd, Cu, and Ag atoms (e.g., Pd—Ag NPs). In this technique, the sacrificial metal template (e.g., Ag) with a higher oxidation potential is replaced with the nanocage metal (e.g., Pd). The size and shape of the resulting NPs metal can be engineered by changing the size and shape of the metal template. In addition, the pore size is optimized so that reactants can diffuse in and products can diffuse out of the cavity while not reducing the surface area considerably due to the increase in the pore size in the walls and corners of the nanocages. Due to the lattice mismatch between Pd (3.890 Å) and Ag (4.086 Å), when Pd²⁺ precursor is added to the solution of Ag NPs, islands of palladium are formed on the Ag surface. Further addition of Pd salt solution causes the islands to grow and create a rough and porous surface layer. The reduction of Pd²⁺ to Pd^{o} is accomplished through two different mechanisms. First, the galvanic replacement process (Pd²⁺_{(aq.)}+2Ag⁰₍ₛ₎→Pd⁰₍ₛ₎+2Ag⁺_{(aq.)}) leads to the formation of a hollow Pd—Ag nanostructure. The second mechanism is an island-growth mode that creates a continuous porous layer of Pd on Ag at the exterior surface.

In one embodiment, the method synthesizes a series of single-atom alloyed (SAA) catalysts with varying molar ratios by the incipient wetness co-impregnation (IWI) method. The catalysts are characterized by using advanced microscopic and spectroscopic techniques. This includes X-ray absorption near edge structure (XANES) and extended X-ray absorption fine structure (EXAFS), and high-resolution transmission electron microscopy (TEM). This allows the development of highly selective and efficient catalyst materials (NPs or SAA) incorporated into the system. In one embodiment, this allows close to a 100% conversion rate and greater than 90% selectivity of nitrogen-containing reactants to ammonia. In one embodiment the conversion rate is selected from the group consisting of 50-60%, 55-65%, 60-70%, 65-75%, 70-80%, 75-85%, 80-90%, 85-95% and 90-100%.

In one embodiment, water vapor is used as feedstock. In one embodiment, hydrogen gas from water splitting via electrolysis is used as feedstock. In one embodiment, nitrate in wastewater is used as a nitrogen source, the system is operated under alkaline conditions, and the gaseous ammonia is collected at the output. This is done by running the flow reactor primarily in a gaseous phase to minimize separation and purification steps.

Two different electrochemical cell designs (i.e., flow-by and flow-through modes) are described, using liquid-based waste streams (nitrate present in the fertilizer runoff). Optimizing cell configuration and operating conditions is a primary strategy to enhance mass transfer. Flow cells are instrumental in mitigating these mass transfer issues and offer practical and viable options for commercial and industrial wastewater treatment.

In one embodiment, a flow-through system using porous electrodes (e.g., mesh, membrane) to minimize mass transport losses is employed. In one embodiment, in a flow-through system, wastewater flows through the pores (a few nm up to 1 μm pore size) with a high specific surface area electrode that offers more active sites for electrochemical reactions. In one embodiment, a flow-through system is especially effective when operated with a low concentration (e.g., [NO₃⁻] 0.05M). In one embodiment, the NO₃ concentration is in a range selected from the group consisting of 0.001-0.01M, 0.01-0.1M, 0.5-1.0M The cost of nitrogenous fertilizer production is reduced by accessing cheaper renewable electricity. The cost of nitrogenous fertilizer production is reduced by decreasing the energy input, and/or by improving the durability of catalyst materials with superior selectivity, thereby enabling the operation of electrolyzers for an extended period of time without any noticeable degradation.

Benchmark protocols are used to reliably evaluate the catalytic performance for nitrogenous fertilizer production. System performance, including the products yield, Faradaic efficiency, and energy efficiency using disclosed catalysts, various electrochemical reactors, and feedstocks (e.g., nitrogen source, proton source) under different operating conditions (e.g., flow rate, N concentration, purity) are examined. Multiple analytical techniques and instruments are used to quantify products precisely. The liquid products are analyzed using ¹H nuclear magnetic resonance (NMR) spectroscopy, Ion Chromatography (IC), and liquid chromatography-mass spectrometry (LC-MS). The gaseous products are quantified using Gas Chromatography (GC). Multiple analytical techniques are used in parallel to confirm the accuracy of the method and develop best practices for product quantifications. Control experiments are carried out in which Argon (Ar) and isotopically labeled N₂, or NOₓ, are used as feed gases. ¹⁵N₂ (98 atom % ¹⁵N) must be purified extensively before experiments to remove any N-based impurities.

In one embodiment, a variety of in-situ and operando spectroscopic techniques, including XAS, X-ray photoelectron spectroscopy (XPS), X-ray emission spectroscopy (XES) are utilized, to provide detailed characterizations of the catalysts and to give critical feedback for materials synthesis optimization. In addition, these element-specific electronic structure techniques identify oxidation state/coordination number, adsorption species, and structural changes such as aggregation or agglomeration. The hard x-ray approaches used provide these insights at actual operating conditions, allowing the establishment of accurate geometric-/electronic-structure-selectivity relationships. This reveals sub-1% differences in the presence of all components of the device (e.g., MEA, GDL, electrolyte).

In one embodiment, the durability of the catalysts is prolonged. Durability of the catalyst is measured by identifying particle agglomeration, surface poisoning and/or gradual chemical/structural modification vis-à-vis selected operational conditions. The local mechanical response (i.e., deformation) of the catalysts is monitored using operando atomic force microscopy (AFM). The stiffness of the catalysts is mapped as a function of position, applied potential, and/or current density on the electrode surface (substrate) to find the forbidden regions in reduction and oxidation pathways where catalysts are not stable.

Operando AFM provides a way to link deformation in electrocatalysis. Since hollow particles are necessarily more fragile than their solid counterparts, this information is used when assessing the feasibility of a new nanocatalyst. The properties of hollow double-shell nanoparticles with two different metals are also described, including the role of varying Pd content in hollow Pd—Ag nanocages and measuring the stiffness of the nanoparticles before and after the catalytic reactions.

In one embodiment, a step stress testing protocol, which consists of (i) short-term (<1 day) stability assessment at modest current densities; (ii) increasing the applied current densities in a stepwise manner until Faradaic efficiency is compromised and/or the cell fails; and (iii) running the system for long-term (>1 month) at the highest current density identified may be employed. This technique assumes that a catalyst subject to higher currents leads to intensified reaction rates and faster demonstrations of deactivation. This is performed using the proposed cell configurations to focus on the catalyst and full-cell design. The catalysts and membranes are characterized using standard techniques such as XPS, SEM, TEM, XAS (including XANES and EXAFS), and other standard methods to focus on the physicochemical changes and identify limiting factors of system failure.

In one embodiment, natural waste streams containing nitrate/nitrite ions (e.g., agricultural waste streams) are used to evaluate performance after successfully integrating all components and subcomponents for ammonia synthesis. The results are compared with synthetic matrices and target constituents of analysis to assess performance, especially during long-term experiments using actual samples.

Where scale formation is a problem, scale formation is minimized or mitigated by carefully monitoring the wastewater constituents and controlling the applied potential. In the inevitable case of scale formation, when the redox potentials of target compounds are more negative than the redox potentials of some of the cations (e.g., Ni²⁺, Zn²⁺), pulsed electrolysis or polarity reversal are common strategies to extend the lifetime of the electrode material and maintain the electrocatalytic performance.

TABLE 1
Metrics, including benchmarks and baselines to produce
ammonia and its comparison with the Haber-Bosch Process

| | | | Stretch | Baseline |
|---|---|---|---|---|
| Objective/Goal | Metric | Minimum | Target | Performance |
| Reduce carbon | % Carbon intensity | 90% | 100% | 1.6-ton CO₂e/ ton |
| intensity | change as measured | | | of ammonia |
| | by ton CO₂e/ton | | | |
| | product | | | |
| Production cost | Product cost vs. state | 40% | 60% | $800 per metric |
| | of the art | | | ton of ammonia |
| Logistics cost | Cost of shipping a | 75% | 90% | $80 per metric |
| | ton of ammonia | | | ton of ammonia |
| Unit maintenance | % Of the total cost | 30% | 50% | 15% of the total |
| cost | of the unit | | | unit cost |
| Reaction | Desired product | 40% | 60% | 60% in the multi- |
| selectivity | formed/undesired | | | pass Haber-Bosch |
| | product formed | | | process |
| Reduce energy | MWh/ton product | 30% | 40% | ~10 MWh/ton of |
| consumption | | | | ammonia |

In one embodiment, CuRu alloy catalysts are used to facilitate NO3RR. The performance of CuₓRu_{y} catalysts in NO3RR are evaluated using a combination of electrochemical methods and device engineering techniques across a range of NO₃⁻ concentrations (0.001 M to 0.5 M). Screening of the CuₓRu_{y} catalysts in an H-cell showed a high Faradaic Efficiency for ammonia (FE_{NH3}) and NH₃ yield rate in solutions with high NO₃⁻ concentrations compared to those with low NO₃⁻ concentrations (≤0.05 M). Pulsed electrolysis measurements conducted at lower NO₃⁻ concentrations to mitigate the mass transfer limitation, demonstrate an increase in FE_{NH3} and approximately a 3.75-fold increase in NH₃ yield rate compared to static potentiostatic experiments. In one embodiment, the increase is 2-fold. In one embodiment, the increase is 3-fold. In one embodiment, the increase is 4-fold. In one embodiment, the increase is 5-fold.

Additional device engineering techniques such as utilizing the MEA electrolyzer with anion exchange membrane (AEM) and bipolar membrane (BPM) were employed to enable electrocatalytic conversion of NO3RR to NH₃ at higher current densities and studied the device parameters that affect the NO3RR performances. The CuₓRu_{y} catalyst in an MEA configuration with an anionic membrane, achieves over 90% FE_{NH3} at 200 mA cm⁻² and 50% at 500 mA cm⁻², with the highest NH₃ yield rate of 5.74 mmol h⁻¹ cm⁻² and stability exceeding 100 hours (evaluated at 600 mA cm⁻²). In one embodiment, achieves over 85% FE_{NH3} at 200 mA cm⁻² and 50% at 500 mA cm⁻², with the highest NH₃ yield rate of 5.74 mmol h⁻¹ cm⁻² and stability exceeding 100 hours (evaluated at 600 mA cm⁻²). In one embodiment, achieves over 95% FE_{NH3} at 200 mA cm⁻² and 50% at 500 mA cm⁻², with the highest NH₃ yield rate of 5.74 mmol h⁻¹ cm⁻² and stability exceeding 100 hours (evaluated at 600 mA cm⁻²).

### EXAMPLES

### Example 1

A series of CuₓRu_{y} alloy catalysts (10 wt % loadings) with varying Cu/Ru molar ratios (x/y) dispersed on carbon structure synthesized by a co-impregnation method and applied for electrocatalytic conversion of NO₃⁻ to NH₃. The quantities of Cu and Ru were mole ratios: 100:1, 10:1, 1:1, 1:10, and 100:1, designating the catalysts as Cu₁₀₀Ru₁, Cu₁₀Ru₁, Cu₁Ru₁, Cu₁Ru₁₀, and Cu₁Ru₁₀₀, respectively. The actual Cu/Ru molar ratios in the CuₓRu_{y} alloy catalysts were determined through Inductively Coupled Plasma Mass spectrometry (ICP-MS) Summarized in Table 2.

TABLE 2
A summary of experimental loading of Cu and
Ru and actual loading measured from ICP-MS

| | Carbon | Cu | | | | | |
|---|---|---|---|---|---|---|---|
| Cu:Ru | black | (NO₃)₂•3H20 | Cu | RuCl•H₂0 | Ru | Cu (mg, | Ru (mg, |
| (mol) | (mg) | (mmol/mg) | (mg) | (mmol/mg) | (mg) | ICP-MS) | ICP-MS) |
| 100:1 | 100 | 0.5/120.8 | 31.77 | 0.005/1.37 | 0.505 | 31.05 | 0.493 |
| 10:1 | 100 | 0.5/120.8 | 31.77 | 0.05/10.37 | 5.05 | 31.19 | 4.865 |
| 1:1 | 100 | 0.275/66.44 | 17.47 | 0.275/57.04 | 27.79 | 15.3 | 26.23 |
| 1:10 | 100 | 0.05/12.08 | 3.177 | 0.5/103.7 | 50.05 | 3.18 | 48.35 |
| 1:100 | 100 | 0.005/1.208 | 0.317 | 0.5/103.7 | 50.05 | 1.29 | 49.258 |

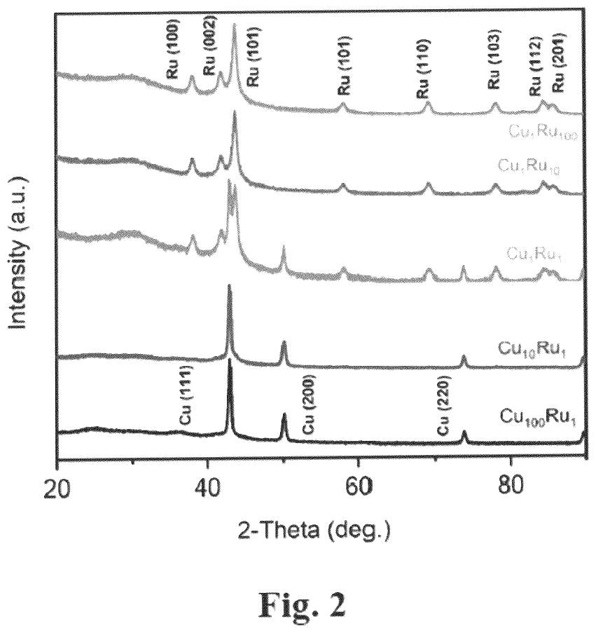

Carbon nanostructures serve as a support to enable the uniform dispersion of CuₓRu_{y} nanoparticles, thereby enhancing their utilization through increased active sites and improved electrical conductivity in the catalyst system. The crystalline structure of synthesized samples is characterized using X-ray diffraction spectroscopy (FIG. 2).

The XRD patterns of Cu₁₀₀Ru₁ and Cu₁₀Ru₁ exhibit three main Bragg reflection peaks at 20 values of 43.38°, 50.34°, and 73.94°, corresponding to the (1 1 1), (2 0 0), and (2 2 0) planes related to metallic Cu, (with no peaks corresponding to Ru observed.

In contrast, the XRD patterns of Cu₁Ru₁₀ and Cu₁Ru₁₀₀ show sharp diffraction peaks centered at 38.4° (100), 42.1° (002), 44.0° (101), 58.3° (102), 69.4° (110), 78.4° (103), 84.7° (112), and 85.9° (201), associated with metallic ruthenium (Ru). Notably, the Cu₁₀Ru₁ sample exhibits peaks corresponding to both Cu and Ru, suggesting the formation of a CuRu alloy structure.

These XRD results indicate that the Cu peaks diminish with increasing Ru content, while no Cu peaks are observed in samples with higher Ru content. Moreover, no detectable impurity peaks for oxides were found in the XRD pattern, further supporting the formation of a CuRu alloy structure.

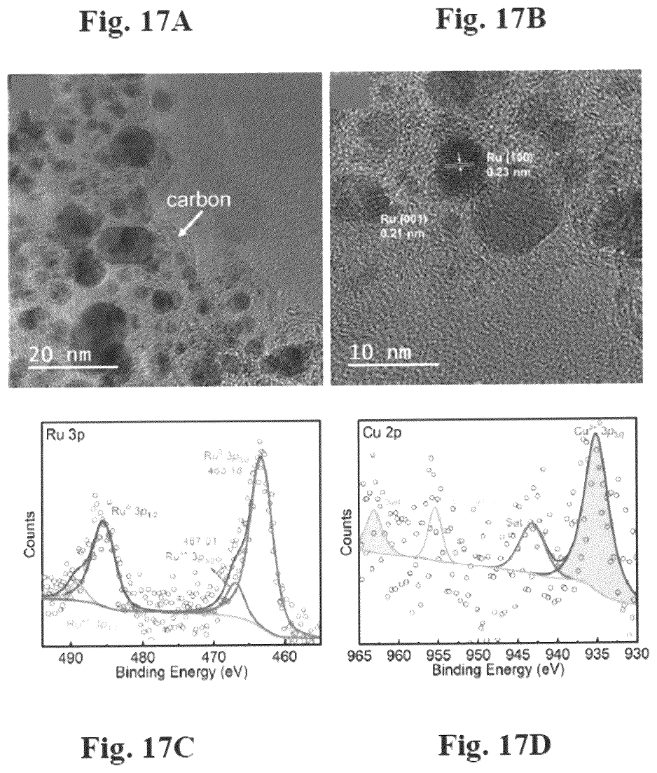

The transmission electron microscopy (TEM) image of Cu₁Ru₁₀ sample shows nanoparticles with a diameter ranging from 3-15 nm decorating the carbon surface (FIG. 17A). The interplanar spacing of Ru₁Cu₁₀ is found to be 0.21 and 0.23 nm, which is consistent with the (001) and (100) facets of hexagonal close-packed Ru (FIG. 17B).

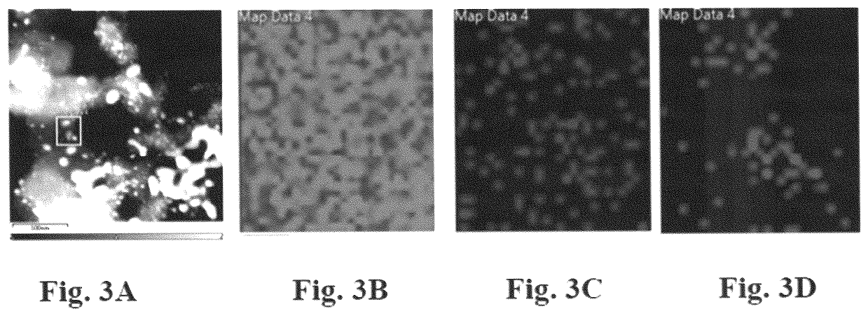

The high-resolution TEM (HR-TEM) images present in the FIGS. 17A and 17B distinctly display lattice fringes of 0.245 nm, corresponding to the (101) facet of metallic Ru. These results are consistent with the XRD data. Additionally, the energy-dispersive X-ray spectrometry (EDX) elemental mapping of the Cu₁Ru₁₀ (FIG. 3) illustrates uniform distribution of Ru and Cu on the carbon substrate and confirms the formation of CuRu alloy nanostructures.

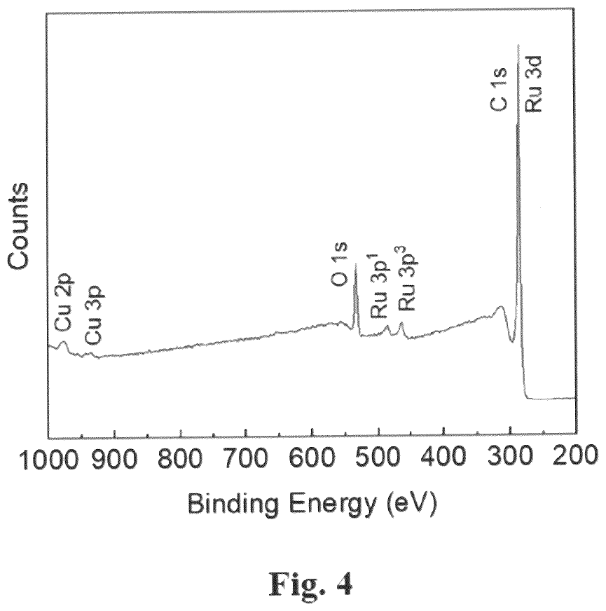

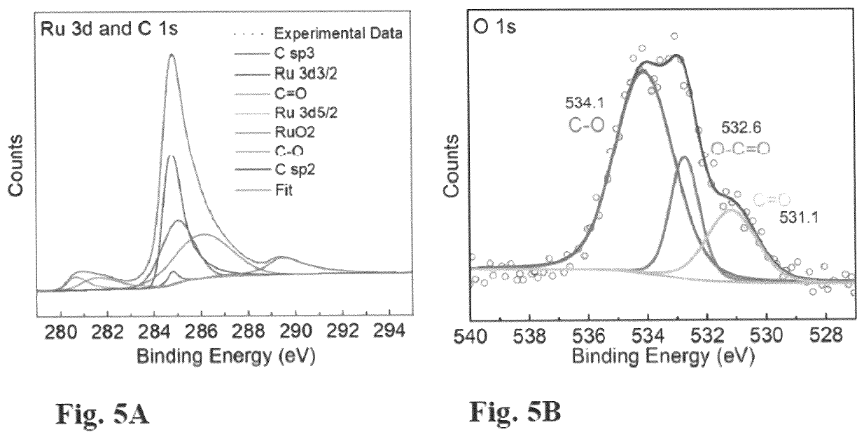

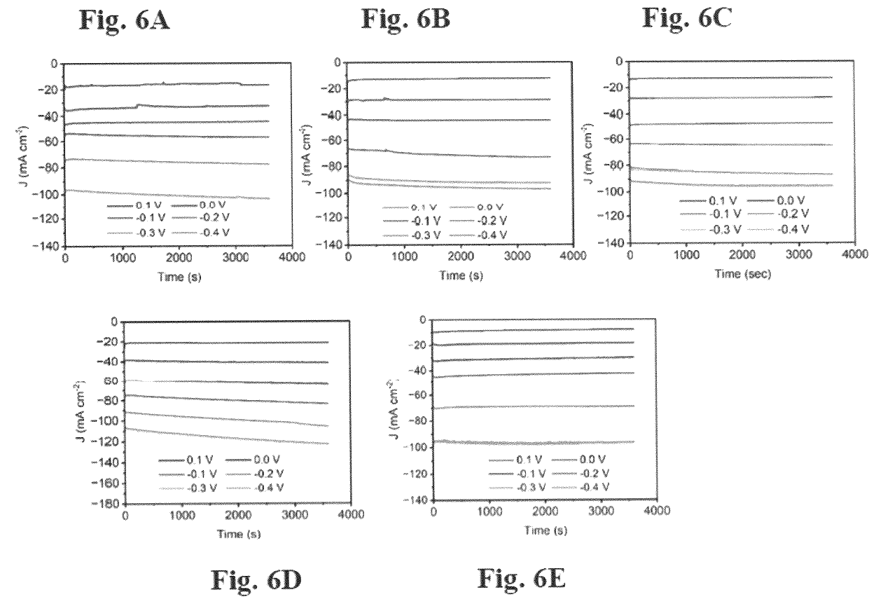

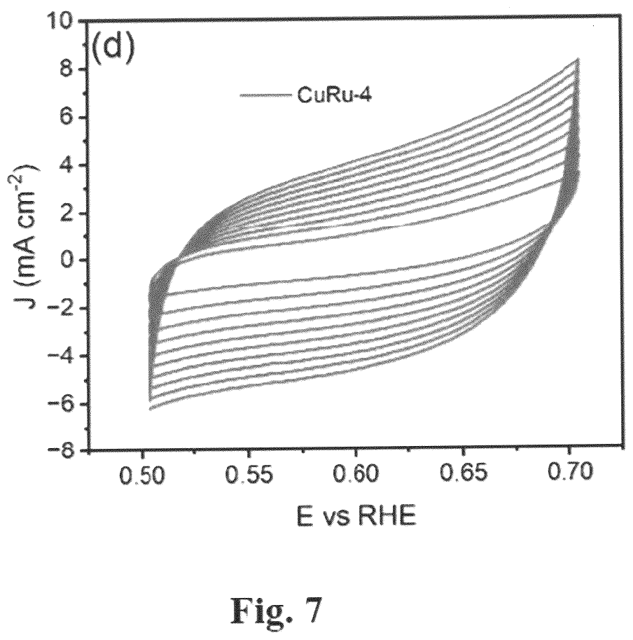

Insight into the chemical structure and composition of the CuₓRu_{y} catalysts are obtained from X-ray photoelectron spectroscopy (XPS). The XPS survey spectra of Cu₁Ru₁₀ manifested the coexistence of Cu, Ru, and C elements (FIG. 4). FIG. 5A shows the XPS spectra of C is data overlaps with Ru 3d_{3/2} data, making it difficult to study the oxidation state of Ru using the Ru 3d_{3/2} XPS signal. The deconvoluted Ru 3d₅/2 XPS signal of Cu₁Ru₁₀ fitted at 280.6 eV is ascribed to the Ru, while the other peak at 281.5 eV is assigned to the characteristic peak of Ru—O. The distinct chemical composition of Ru is further verified through the high-resolution Ru 3p XPS spectrum. The figure displays two fitting peaks in the 3p_{3/2} region at 462.6 and 465.2 eV, corresponding to Ru⁰ and Ru⁴ peaks, respectively, which align well with previous study findings on Ru and RuO₂(FIG. 17C). The high-resolution Cu 2p XPS spectra reveal peaks at 934.9 (Cu 2p_{3/2}) and 954.7 eV (Cu 2p_{1/2}) along with two satellite peaks at 942.6 and 962.7 eV, assigned to zero-valent Cu (FIG. 17D). No peaks corresponding to Cu²⁺ were observed for Cu₁Ru₁₀ catalysts. The O 1s spectra showed the three peaks at 531.2 eV, 532.3 eV, and 534 eV are related to surface adsorbed oxygen, —C—O, and the adsorbed hydroxyl species (FIG. 5B), eliminating the formation of oxide structures as observed in the XRD. All these characterization studies confirm the successful synthesis of CuRu alloy nanostructures.

### Example 2

### Synthesis of CuRu/Copper Based (CuRu/CB) Catalysts:

To 50 mL ethanolic solution containing 100.0 mg of carbon black, add desired amounts of Cu and Ru precursors such that the ratio of metals to carbon is 1:100 or 5:100. The amount of Cu and Ru for different samples were chosen such that the mole ratio of Cu:Ru should be 100:1, 10:1, 1:1, 1:10, 100:1. The solution was stirred vigorously for 8.0 h at room temperature and then heated to ˜80.0° C. until a dry powder is obtained. The resultant is collected and annealed at 600.0° C. for 3.0 h in 5.0% H₂/Argon mixture. The concentration precursors taken and % wt of Ru and Cu are shown in Table 3.

TABLE 3
A summary of starting concentrations and yield of Ru and Cu

| Cu:Ru (Molar | Conc. of | Conc. of RuCl₃ | Wt % | Wt % |
|---|---|---|---|---|
| ratio) | Cu(NO₃)₂ (moles) | (moles) | of Cu | of Ru |
| 1:100 | 0.25 | 0.0025 | 0.16 | 25.3 |
| 1:10 | 0.005 | 0.05 | 0.32 | 5 |
| 1:1 | 0.005 | 0.005 | 0.32 | 0.5 |
| 10:1 | 0.05 | 0.005 | 0.5 | 3.2 |
| 100:1 | 0.0025 | 0.25 | 15.8 | 0.25 |

Materials: Cupric nitrate, ruthenium chloride, carbon black, potassium hydroxide, potassium nitrate, ethanol, sodium perchlorate, sodium hydroxide, salicylic acid, sodium citrate, sodium nitroferricyanide, isopropyl alcohol, DI water.

### Example 3

### Synthesis of PdCu/Copper Based (PdCu/CB) Catalysts:

Existing PdCu/CB catalysts of different compositions (100:1, 3:1, 1:1, 1:3, 1:100) were used as received.

### Preparation of Catalyst Ink and Working Electrodes:

For NO3RR experiments, 20.0 mg of CuRu/CB catalyst is dispersed in 2.0 mL of isopropyl alcohol containing 80.0 μL of Nafion™ solution by sonication for 20.0 min. 0.5 mL of the obtained ink is spray coated on carbon paper of size 1.0 cm×1.0 cm. The catalyst loading, excluding carbon black, is 0.25 mg cm⁻².

### Example 4: Electrochemical Experiments

Electrochemical NO3RR experiments are conducted in Argon (Ar) saturated 0.1 M KOH electrolyte either with or without 0.5 M KNO₃.

Linear sweep voltammetry and cyclic voltammetry experiments are conducted using a three-electrode electrochemical set-up. Bulk electrolysis experiments are conducted in an H-Cell set-up consisting of working electrode and reference electrode in one compartment, and anode in another compartment. Respective gases (Ar for NO3RR) are continuously purged in the cathodic compartment during the electrolysis experiments. Chronoamperometry is used to run electrolysis experiments at selected applied potentials. Electrolysis is performed for the duration of 1.0 h. All potentials reported are in RHE (Reversible Hydrogen Electrode) scale. Potentials measured using Ag/AgCl (1.0 M KCl) are converted to RHE using equation (3)

$${E}_{RHE} = {E}_{Ag / AgCl} + 0.222 V + 0.0591 ( pH ) \qquad ( Eq . 3 )$$

Potentials measured using Hg/HgO were converted to RHE using the equation (4)

$${E}_{RHE} = {E}_{hg / HgO} + 0.098 V + 0.0591 ( pH ) \qquad ( Eq . 4 )$$

### Example 5: Product Quantification

Ammonia is quantified using the indophenol blue method. In the typical procedure, 2.0 mL of electrolyte is added to a 2.0 mL solution mixture containing 1.0 M NaOH, 5.0% salicylic acid and 5.0% sodium citrate. To this 1.0 mL of 0.05 M NaClO solution and 0.25 mL of sodium nitroferricyanide are added. The obtained solution mixture is shaken a few times and left undisturbed for 2.0 h. The absorbance of obtained solution at 655.0 nm is measured using UV-Vis spectroscopy.

The faradaic efficiency of the products is estimated using Equations (5) and (6)

$${FE}_{{NH}_{3}} ( \% ) = \frac{n * C * F * V}{17 * Q} \qquad ( Eq . 5 )$$

$${FE}_{Urea} ( \% ) = \frac{n * C * F * V}{60.06 * Q} \qquad ( Eq . 6 )$$

where n is the number of electrons transferred, C is the concentration of the product, F is Faraday's constant, V is the volume of the electrolyte and Q is the charge passed during electrolysis.

Yield of the product in different units is calculated using equations (7)-(10)

$$Yield ( mol {h}^{- 1} {g}_{cat}^{- 1} ) = \frac{C * V}{z * t * {m}_{cat}} \qquad ( Eq . 7 )$$

$$Yield ( g {h}^{- 1} {g}_{cat}^{- 1} ) = \frac{C * V}{t * {m}_{cat}} \qquad ( Eq . 8 )$$

$$Yield ( mol {h}^{- 1} {cm}^{- 2} ) = \frac{C * V}{z * t * A} \qquad ( Eq . 9 )$$

$$Yield ( g {h}^{- 1} {cm}^{- 2} ) = \frac{C * V}{t * A} \qquad ( Eq . 10 )$$

where C is the concentration of the product, V is the volume of the electrolyte, z is the molecular weight of the product, m_{cat} is the mass of the catalyst and A is the area of the electrode.

### Example 6: Determination of NO₂⁻

A specific color reagent for NO₂⁻ quantification was prepared by dissolving 0.20 g of N-(1-naphthyl) ethylene diamine dihydrochloride and 4.0 g of sulfonamide in a mixed solution of 10 mL of phosphoric acid (85 wt. % in H₂O) and 50 mL of deionized water. Then, 0.1 mL of the color reagent was added to 5 mL of the diluted post-electrolysis electrolyte solution. The absorbance was determined by UV-Vis spectrophotometry at 540 nm after 20 min. The amount of NO₂⁻ was measured using a calibration curve of NaNO₂ (≥99%) solutions.

### Example 7: Determination of NO₃⁻

### Computation of Conversion Rate, Yield and Faraday Efficiency (FE)

$$Faradaic efficiency = {FE}_{N H 3} = ( n \times F \times {C}_{N H 3} \times V ) / ( 17 \times Q ) \qquad ( Eq . 11 )$$

$$Yield {NH}_{3} = {Y}_{N H 3} = ( {C}_{N H 3} \times V ) / ( m \times t ) \qquad ( Eq . 12 )$$

$$Faradaic efficiency = {FE}_{N O {2}^{-}} = ( 2 \times F \times {C}_{N O {2}^{-}} \times V ) / ( 46 \times Q ) \qquad ( Eq . 13 )$$

where F is the Faraday constant (96,485 C-mol⁻¹), n represents the number of electron transfers towards the formation of 1 mol of ammonia which is 8, C_{NH3} is the molar concentration of detected ammonia, m is the loading mass of the catalysts, V is the volume of the electrolytes, A is the electrode geometric area, and t is the reaction time, Q is the e total charge passing through the electrodes during electrolysis.

### Example 8: Energy Efficiency Calculation

The half-cell energy efficiency of ammonia (EENH3) was defined as the ratio of fuel energy to applied electrical power, which was calculated with the following equation:

$$Half - cell {EE}_{NH 3} = \frac{1.23 - {E}_{NH 3}^{0}}{1.23 - E} \times F {E}_{N H 3} \qquad ( Eq 14 )$$

$$Full cell {EE}_{NH 3} = \frac{1.23 - {E}_{NH 3}^{0}}{1.23 - E} \times F {E}_{N H 3} \qquad ( Eq 15 )$$

Where EE_{NH3} is the equilibrium potential of nitrate electroreduction to ammonia (0.69 V vs. RHE in 0.1 M KOH), FE_{NH3} is the Faradaic efficiency for NH₃, E is the applied potential (vs. RHE) for half-cell, and total cell voltage for full cell. 1.23 V is the equilibrium potential of water oxidation, when assuming the overpotential of the water oxidation is zero

### Example 9: Energy Consumption

The energy consumption (EC, kWh kgNH3-1) for electrocatalytic NO3- to ammonia conversion was obtained assuming the overpotential of the water oxidation at anode is zero.

$${E}_{C} = n \times F \times ( 1.23 - E ) / 3600 \times m \times FE ) \qquad ( Eq 16 )$$

where n is the electron number for producing ammonia (n=8); E is the applied potential (vs. RHE) for NH₃ production; m is the mole mass of NH₃ (17 g mol⁻¹); FE is the Faradaic efficiency.

### Example 10: Turnover Frequency Calculations (TOF)

The TOF was calculated by the following formula;

$$TOF = moles of product formed / ( moles of caralyst \times time ( s ) ) \qquad ( Eq 17 )$$

### Example 11

TABLE 4
Comparing the performance of synthesized CuₓRu_{y} catalysts with
other reported electrocatalysts for NO3RR in alkaline media

| | | Applied | | NH₃ yield | Half-cell |
|---|---|---|---|---|---|
| | | potential | FE | rate (mmol | efficiency |
| Catalysts | Electrolyte | (V vs. RHE) | (%) | h⁻¹ cm⁻²) | EENH3 (%) |
| (Cu_{0.6}Co_{0.4})Co₂O₄ | 1.0M KOH+ | −0.45 | 96.5 | 1.09 | N/A |
| | 0.1M KNO₃ | | | | |
| Cu@Th-BPYDC | 1M KOH + | −0.2 | 92.5 | 0.2253 | N/A |
| | 0.1M KNO₃ | | | | |
| Ni₃₅/NC-sd | 0.5M Na₂SO₄ + | | 99 | 0.3 | N/A |
| | 0.3M KNO₃ | | | | |
| CuCoSP | 0.01M KNO₃ + | −0.175 | 93.3 | 1.17 | 36 |
| | 0.1M KOH | | | | |
| Cu nanosheets | 1M KOH + | −0.36 | 95 | 1.01 | 32.6 |
| | 0.2M KNO₃ | | | | |
| Cu₂O + Co₃O₄ | 0.1M NaNO₃ + | −0.3 | 85.4 | 0.75 | N/A |
| | 0.1M NaOH | | | | |
| Cu-NBS-100 | 1M KOH + | −0.15 | 95 | 0.65 | |
| | 0.1M KNO₃ | | | | |

### Electrochemical NO3RR Performance

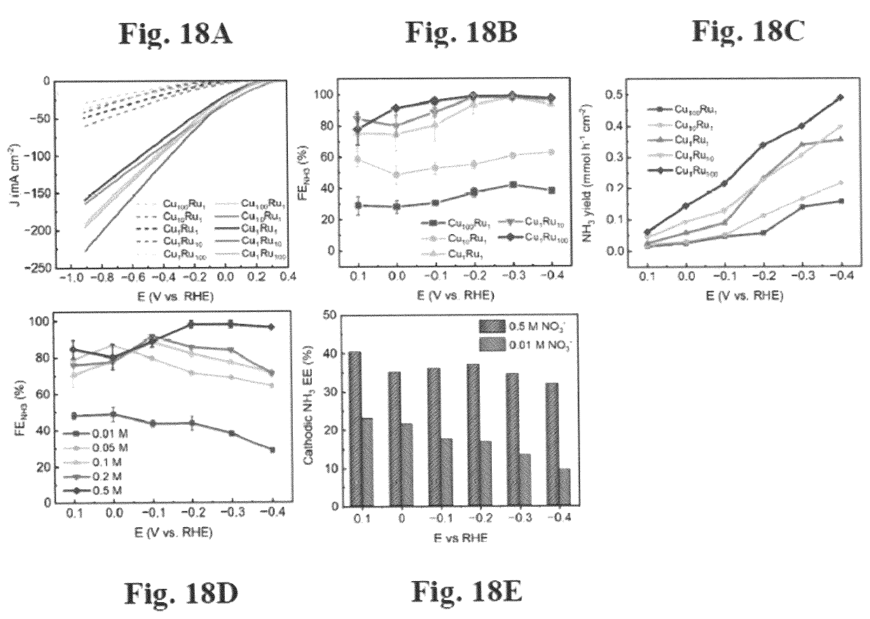

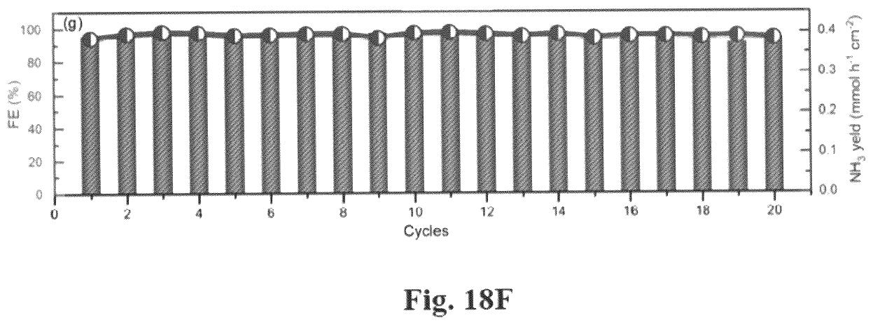

The electrochemical performance of CuₓRu_{y} catalyst for the NO3RR was systematically investigated in a custom H-cell under ambient conditions. Linear sweep voltammetry (LSV) was conducted in 0.1 M KOH with and without 0.5 M NO₃. High-purity argon gas was bubbled into the cathodic chamber before electroreduction to remove any dissolved oxygen gas and prevent possible side-competitive reactions. All the CuₓRu_{y} catalysts demonstrated increased current densities in the presence of NO₃⁻, with Cu₁Ru₁₀ exhibiting the highest current density compared to other CuₓRu_{y} catalysts within the same potential range, indicating its superior activity for the NO3RR. The corresponding NO3RR current density of the Cu₁Ru₁₀ (228 mA cm⁻²) was much higher than those of the Cu₁₀₀Ru₁ (190 mA cm⁻²), Cu₁₀Ru₁ (165 mA cm⁻²), Cu₁Ru₁ (161 mA cm⁻²), and Cu₁Ru₁₀₀ (198 mA cm⁻²) at a potential of −0.9 V vs. RHE. Subsequent chronoamperometry experiments at different potentials over 1 hour allowed for quantification of NO3RR activity and selectivity. Product analysis, including nitrite (NO₂⁻), and NH₃ were quantified by UV-vis spectrometry with calibration curves) and H₂ gas was quantified using gas chromatography (GC). Interestingly, the CuₓRu_{y} catalysts with higher Ru content (Cu₁Ru₁, Cu₁Ru₁₀ and Cu₁Ru₁₀₀) exhibit the high NH₃ Faradaic efficiency (FE_{NH3}) exceeding 95% at −0.2 V to −0.4 V (FIG. 18B), resulting in NH₃ yields of 0.36±0.013 mmol h⁻¹ cm 2, 0.4±0.011 mmol h⁻¹ cm⁻², and 0.49±0.018 mmol h⁻¹ cm⁻² for Cu₁Ru₁, Cu₁Ru₁₀, and Cu₁Ru₁₀₀ at −0.4 V vs. RHE (FIG. 18C). Both Cu₁Ru₁₀ and Cu₁Ru₁₀₀ exhibited similar FE_{NH3} values, however, the NH₃ yield rate was higher with Cu₁Ru₁₀₀ (FIG. 18C). Notably, the FE_{NH3} and NH₃ yield rates are comparable to that on many other reported electrocatalysts (Table 4). In contrast, Cu₁₀₀Ru₁, and Cu₁₀Ru₁ with lower Ru content, show the FE_{NH3} of 38% and 62% at a potential of −0.4 V with corresponding yields of 0.15 mmol h⁻¹ cm⁻² and 0.21 mmol h⁻¹ cm 2, respectively. Increasing the Ru concentration heavily impacted the catalytic nature of the CuₓRu_{y} catalyst for multi-step NO₃⁻ to NH₃ conversion. The catalytic activity of Cu₁₀₀Ru₁ and Cu₁₀Ru₁ is compromised due to their high Cu content, leading to Cu poisoning caused by the strong adsorption strength of NO3RR reduction intermediates (NO₂⁻ and NO) and insufficient hydrogen (*H) supply for the hydrogenation of NO₂⁻ over Cu. Whereas, Ru with high coverage of active *H on its surface ensure the rapid hydrogenation of NO₂⁻ to NH₃. The electrochemical surface area (ECSA), measured by double-layer capacitance (C_{dl}), further corroborates the high intrinsic performance of CuₓRu_{y} catalysts. The C_{dl} values for Cu₁₀₀Ru₁, Cu₁₀Ru₁, Cu₁Ru₁, Cu₁Ru₁₀, and Cu₁Ru₁₀₀ were recorded as 12.1, 17.4, 24.6, 38.2, and 42.1 mF cm⁻², respectively, aligning well with the NO3RR activity of CuₓRu_{y} catalysts.

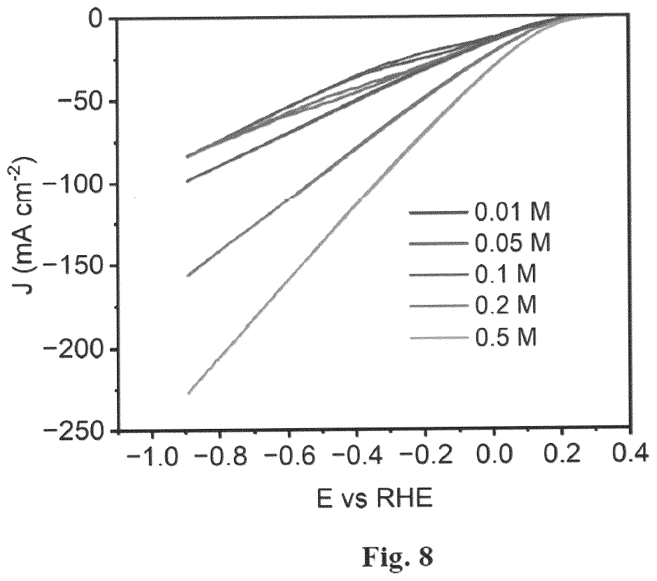

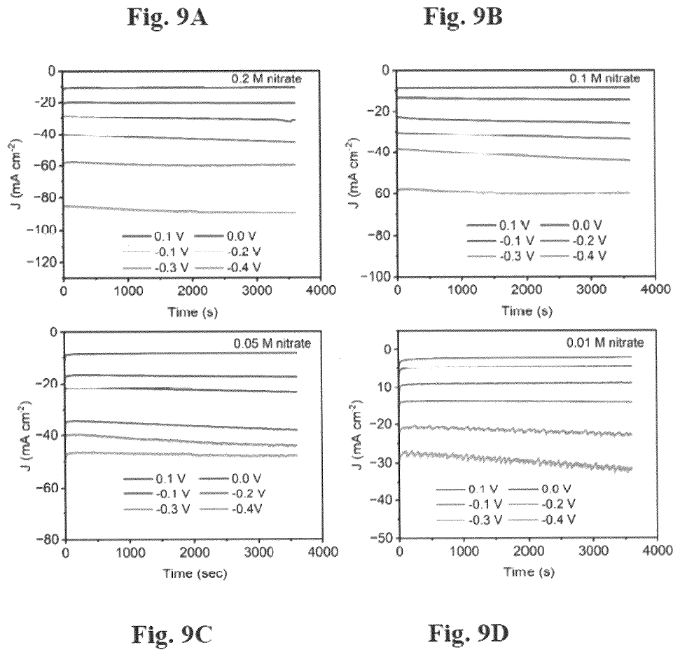

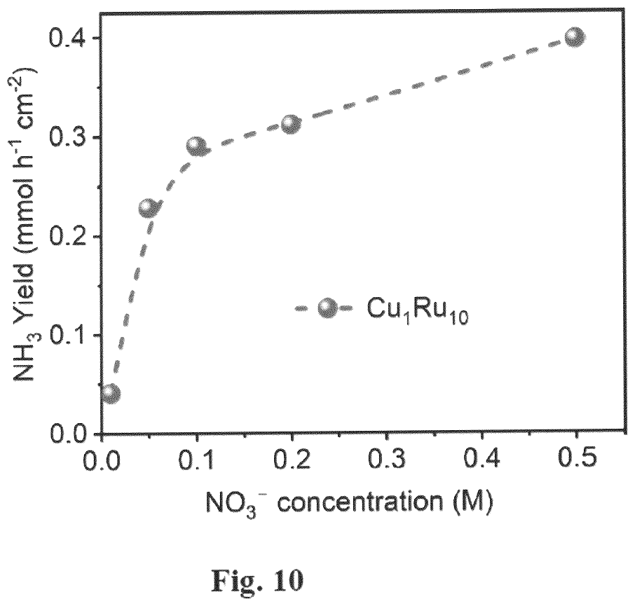

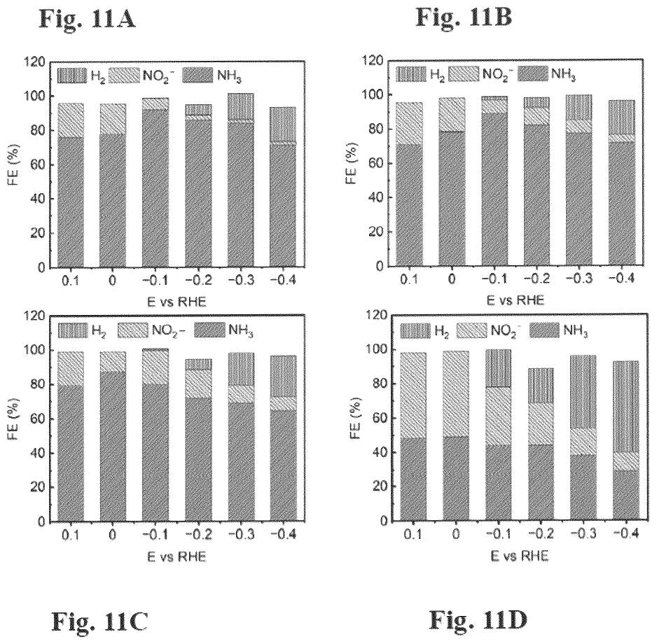

To emphasize the broad applicability, NO3RR performance of CuₓRu_{y} catalysts was examined across various concentrations ranging from 0.01 to 0.5 M NO₃⁻, covering the broad spectrum of NO₃⁻ containing wastewater sources such as textile wastewater and the nuclear industry. The investigation focused on the catalytic performance of Cu₁Ru₁₀ catalysts for NO3RR across different NO₃⁻ concentrations, leveraging their high current density under 0.5 M NO₃⁻ conditions. As illustrated in the FIG. 8, the current density increases with an increase in NO₃⁻ concentration from 0.01 M to 0.5 M. These results suggest that the NO3RR activity is restricted by mass transfer limitation in the lower NO₃⁻ concentrations. Experimental findings demonstrate that Cu₁Ru₁₀ displayed higher FE_{NH3} and NH₃ yield rates under higher NO3 concentrations ranging from 0.1 to 0.5 M (FIGS. 18D and 10). However, the catalyst presented moderate performance under 0.01 M NO₃⁻ and delivered a 60 mA cm⁻² current density with FE_{NH3} of ˜30% and NH₃ yield of 0.041±0.01 mmol h⁻¹ cm⁻² at −0.4 V vs. RHE. The quantification of the main byproducts including NO₂⁻ and H₂ was also quantified, revealing a notable increase in their concentrations as the NO₃⁻ concentration decreases (FIG. 11). This phenomenon is attributed to the sluggish kinetic rates and limited mass transfer of NO₃⁻ ions at lower concentrations, leading to the accumulation of NO₂⁻ intermediates at lower potentials and a predominance of the HER at higher potentials. The results are well aligned with previous literature reports, showing that higher amount of NO₂⁻ is primarily produced at lower potentials due to the faster reaction rate of NO₃⁻ to NO₂⁻, while HER becomes more pronounced at higher negative potentials especially when the NO₃⁻ concentration is low. ¹⁸ However, increased NO₃⁻ concentration in the electrolyte reduces mass transport limitations, leading to a tenfold increase in NH₃ yield rate as NO₃⁻ concentration rises from 0.01 to 0.5 M. The half-cell energy efficiency (EE) of these catalysts that can reflect the performance of the working electrode are further evaluated in a three-electrode system without considering the overpotential of the anodic oxygen evolution reaction. The Cu₁Ru₁₀ achieves NH₃ half-cell energy efficiency (EE) of 32% at potential of −0.4 V in 0.5 M NO₃⁻ (FIG. 18E), whereas a peak value of 9.5% is achieved in 0.01 M NO₃⁻ at a similar potential. Furthermore, it is worth noting that the high performance of Cu₁Ru₁₀ was maintained well for 20 continuous cycles of chronoamperometry tests at a potential of −0.4 V vs. RHE and the results displayed a stable FE_{NH3} exceeding 93% over the cycles, suggesting excellent stability of the catalyst.

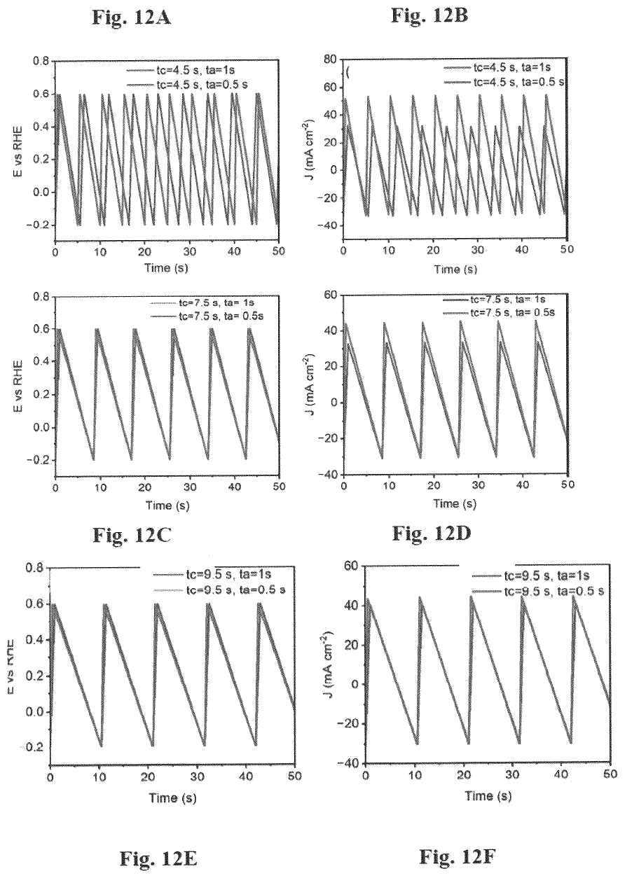

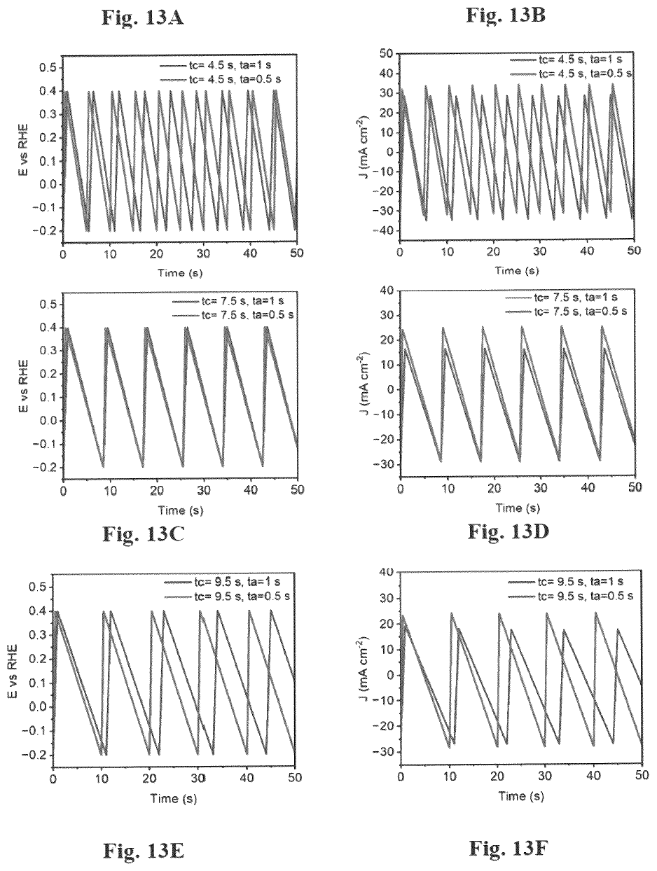

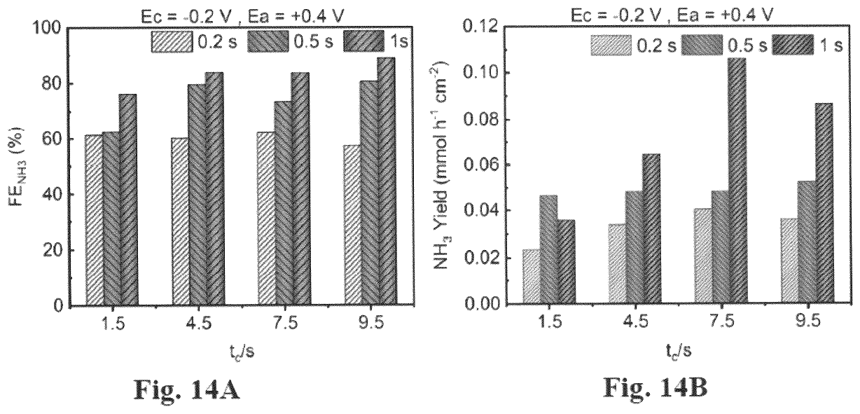

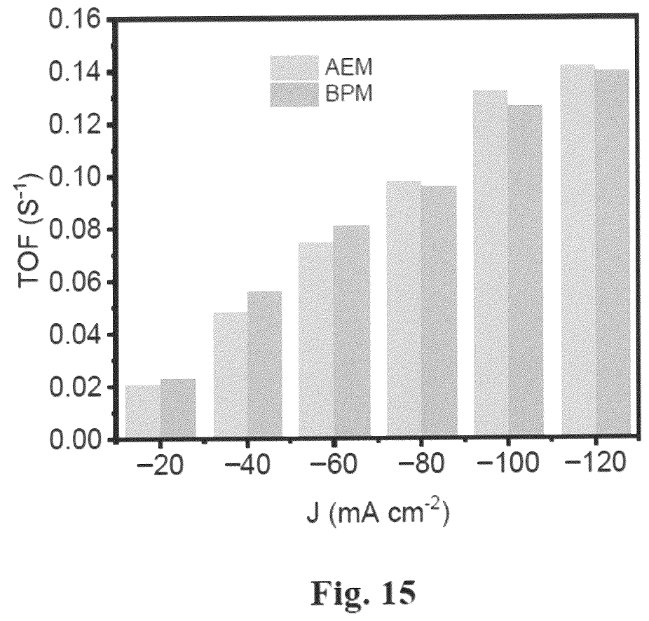

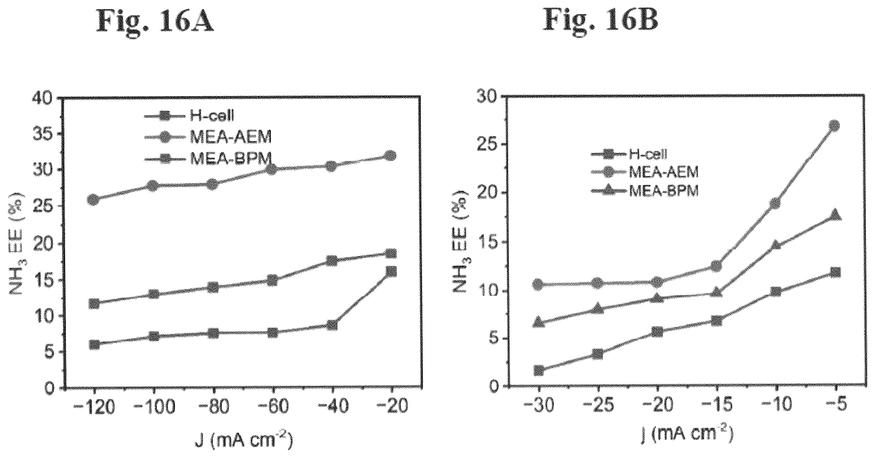

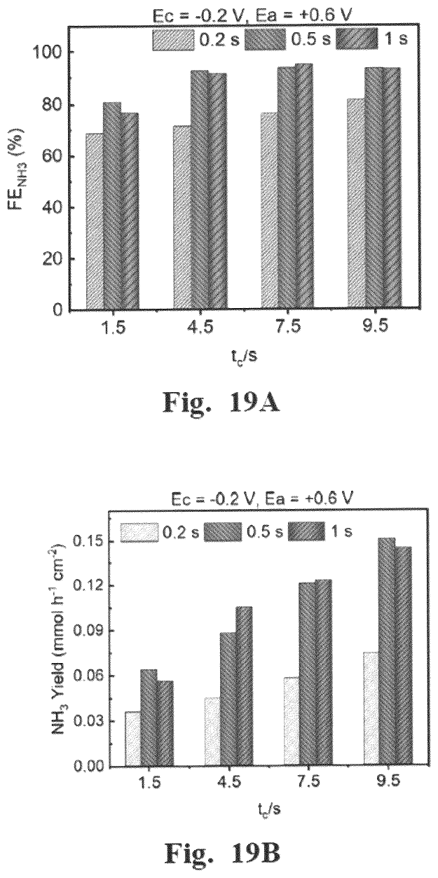

To address the low FE_{NH3} and NH₃ yield rates at the presence of low NO₃⁻ concentration (0.001M-0.01M), pulse electrolysis was further employed to simultaneously accelerate the sequential NO3RR reactions while suppressing the formation of NO2 intermediates and HER. FIG. 19A depicts the typical pulse sequence for NO3RR, starting with cathodic potential (E_{c}) for t_{c} seconds, followed by anodic potential (Eₐ) for tₐ seconds, with the alternating change in potential repeating. Notably, E_{c} was set at a negative potential of −0.2 V, given the observed high FE_{NH3} for Cu₁Ru₁₀ under 0.5 M NO₃⁻, while Eₐ was applied at 0.4 and 0.6 V with different pulse durations (Eₐ=0.2, 0.5, 1 s and E_{c}=1.5, 4.5, 7.5 and 9.5 s). In all pulse electrolysis experiments, the total duration was maintained at 60 minutes, regardless of the time at tₐ, which yielded a negligible amount of ammonia. The total charge passed through the electrode during pulse electrolysis, including both t_{c} and tₐ, was considered in the calculation of FE. The typical i-t curves of pulsed NO3RR at various t_{c} and tₐ shown in FIGS. 12 and 13. As depicted in FIGS. 19A and B, the pulsed electroreduction of nitrate catalyzed by Cu₁Ru₁₀ demonstrates significantly improved FE_{NH3} and yield rates for NH₃ production compared to conventional constant potential electrolysis (static electrolysis) at 0.01M NO₃⁻ concentrations. Specifically, at optimized conditions (Eₐ=+0.6 V, Ec=−0.2 V, tc 7.5 s, ta 1 s), FE_{NH3} reaches 94.6%, which is twice as high as that achieved under static electrolysis conditions at −0.2 V. Furthermore, pulsed NO₃⁻ reduction exhibits a ˜3.75-fold increase in the NH₃ yield rate (FIG. 19B), reaching 0.15 mmol h⁻¹ cm⁻² compared to static electrolysis condition (0.04 mmol h⁻¹ cm⁻² at −0.4 V). It is noted that a slight reduction in FE_{NH3} (83.6%) and NH₃ yield rates were observed when the Eₐ=+0.4 V was applied (FIG. 14). Besides, a significant reduction in NO₂⁻ byproduct and H₂ evolution observed in pulsed electrolysis, which is due to the faster NO₂⁻ to NH₃ conversion. The improved FE_{NH3} and NH₃ yield rates are ascribed to improved mass transfer of NO₃⁻ species, facilitated by the periodic appearance of positive voltage replenish the negatively charged NO₃⁻ ions near the working electrode and suppress the competitive HER.

Furthermore, aside from addressing mass transport limitations, the zero-gap MEA electrolyzers are also appealing for achieving higher current densities while minimizing applied cell voltages, following matured fuel cell technology. The MEA cell stands out from the conventional H-cell by reducing the distance between the electrodes, leading to a substantial decrease in ohmic resistance. This advancement renders it more viable for commercialization, presenting an enticing solution to further elevate the performance of NO3RR to meet commercial standards. The MEA cell comprising an anion exchange membrane (AEM), is particularly promising for use with alkaline electrolytes due to its mitigation of the HER. However, the high permeability of AEM to NO₃⁻ leads to the crossover of NO₃⁻ to anolytes and inherently decreasing the conversion efficiency of NO₃⁻ to NH₃ in AEM-based setups. Integrating a bipolar membrane (BPM) with the MEA system (MEA-BPM) presents a promising approach to address the challenges hindering the MEA-AEM setup. The BPM is composed of a polymeric cation-exchange layer (CEL) and a polymeric anion-exchange layer (AEL), which has been demonstrated to successfully impede the crossover of ions and products during electrolysis. Additionally, BPM reactor offers a potential solution to the inherent conflict between the need for proton elements in the 8-electron nitrate reduction reaction and the necessity of suppressing the HER at cathodic catalytic sites. However, under reverse bias conditions (with the cation exchange layer facing the cathode and the anion exchange layer facing the anode), water dissociation into H⁺ and OH⁻ at the interlayer of the bipolar membrane (BPM) necessitates additional overpotentials, resulting in a notable increase in cell voltage when employing BPM configurations. Nevertheless, there has been a limited amount of research conducted to evaluate the feasibility of NO3RR under high currents using both MEA-AEM and MEA-BPM setups, highlighting the need for further research before NO3RR can progress towards commercial applications. Therefore, examining the impact of various ion-exchange membranes on NO3RR performance and comparing different metrics would assist in evaluating their potential for practical applications.

The superiority of the MEA cell over the H-cell was first demonstrated by measuring the corresponding cell voltages in both setups while applying similar current densities. The MEA cell was constructed using a Cu₁Ru₁₀-coated gas/liquid diffusion electrode with either an AEM (Fumasep, FAA-3-30) or BPM (Fumasep FBM) membrane. To eliminate the mass transfer limitation in MEA, catholyte and anolyte were pumped at a flow rate of 50 ml min⁻¹. The MEA-BPM cell operated under reverse bias conditions. The NO3RR performance of Cu₁Ru₁₀ was evaluated at constant current densities ranging from 20 to 120 mA cm⁻² using a catholyte of 0.1 M KOH+0.5 M KNO₃ and from 5 to 30 mA cm⁻² in a catholyte of 0.1 M KOH+0.01 M KNO₃. Remarkably, the MEA cell exhibited notably lower cell voltages compared to the H-cell in both higher and lower NO₃⁻ concentrations, which can be attributed to the likely enhanced NO₃⁻ mass transport at the catalyst/electrolyte interface on the gas diffusion electrode and the accelerated reaction kinetics of NO3RR.⁵⁵ However, in comparison to the MEA-AEM cell, which required a cell voltage of 1.97 V and 1.95 V, the MEA-BPM necessitated an additional 2.46 V and 1.1 V to achieve a current density of 120 and 30 mA cm⁻², respectively under higher and lower NO₃⁻ concentrations.

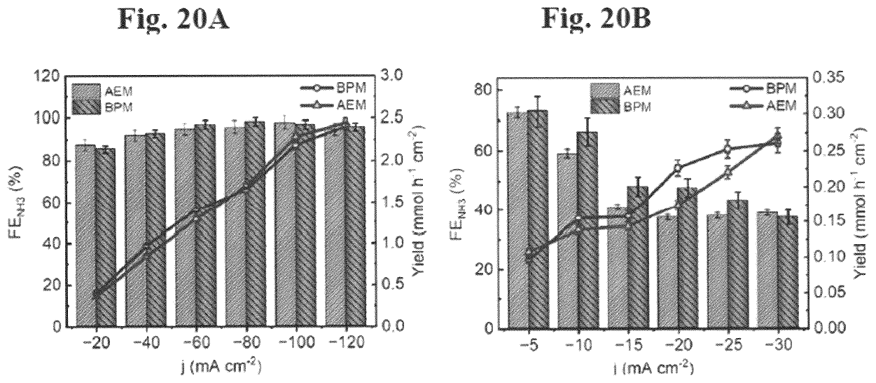

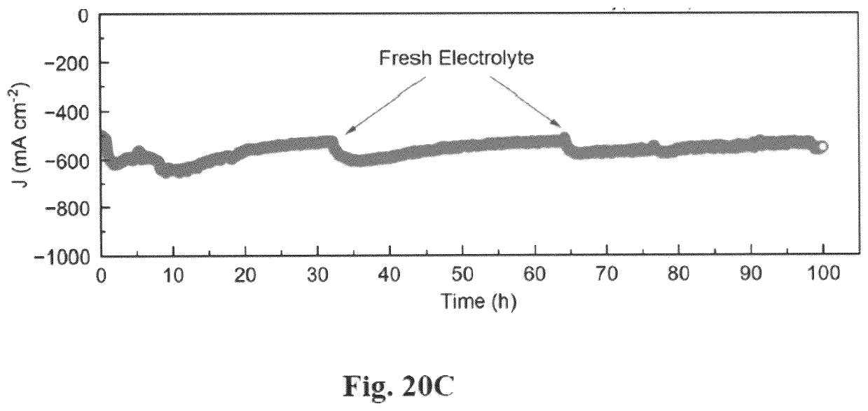

Additionally, both the MEA-AEM and MEA-BPM cells achieved comparable FE_{NH3} and NH₃ yield rates across all operating current densities. Specifically, they reached FE_{NH3} values of 94.5% and 95.8%, and NH₃ yield rates of 2.44 and 2.46 mmol h⁻¹ cm⁻² at a current density of 120 mA cm⁻², respectively (FIG. 20). The Ru-normalized turnover frequency (TOF) of Cu₁Ru₁₀ catalysts in both the MEA-AEM and MEA-BPM setups is calculated to be 0.142 and 0.139 s⁻¹, respectively at a current density of 120 mA cm⁻². Furthermore, the influence of ion-exchange membranes on NO3RR under lower NO₃⁻ concentration, where mass transfer limitations are predominant, was also investigated using the MEA setup with both AEM and BPM configurations. NO3RR experiments conducted in a catholyte of 0.1 M KOH+0.01 M KNO₃ at current densities from 5 to 30 mA cm⁻² revealed slightly higher FE_{NH3} and NH₃ yield rates for the MEA-BPM setup compared to the MEA-AEM setup. The slightly higher NO3RR performance of the MEA-BPM setup is attributed to the stable proton generation from the cation exchange layer (CEL) of BPM, which can accelerate the conversion of NO2 to NH₃, especially in an alkaline medium where the direct H⁺ production pathway is suppressed. It is noted that the NH₃ yield rates observed in the MEA-AEM and MEA-BPM cells are at least three times higher than those observed in the H-cell in lower and higher NO₃⁻ concentrations, indicating a significant enhancement in mass transfer at the electrode-electrolyte interface in the MEA. The results highlight the effectiveness of an MEA cell with both AEM and BPM configurations in achieving higher rates for NO3RR to NH₃ production. The efficiency of an electrochemical process for NH3 production relies significantly on its energy efficiency (EE) and energy input per kilogram of NH₃. The Cu₁Ru₁₀ catalysts in a MEA-AEM cell configuration achieves peak full-cell NH₃ energy efficiency (EE) of 26%, whereas a lower full-cell NH₃ EE of 11.6% is observed for the MEA-BPM cells at a current density of 120 mA cm⁻² (FIG. 20). This discrepancy in NH₃ EE is largely due to the thickness and additional overpotentials required for water dissociation at the interface layer in the MEA-BPM cells, considering the high sensitivity of NH₃ EE to applied potentials. Furthermore, Cu₁Ru₁₀ attained the energy input of 6 kWh/kg_{NH3}.

It is noted that the above all NO3RR experiments performed in a low conductive electrolyte (0.1 M KOH), which restricts achieving higher current densities even in MEA configurations. To overcome this limitation, the electrocatalytic performance of Cu₁Ru₁₀ was additionally assessed in MEA-AEM and MEA-BPM setups, employing a constant current density in a catholyte comprising 1 M KOH with 0.5 M NO₃⁻, along with an anolyte containing 1 M KOH. In both MEA cells, the Cu₁Ru₁₀ catalysts maintained an FE_{NH3} of >90% at current densities of 100 and 200 mA cm⁻². However, the FE_{NH3} steadily decreased, reaching 49.3% with an NH₃ yield rate of 5.74 mmol cm⁻² h⁻¹ at a current density of 500 mA cm⁻² in the MEA-AEM setup. The MEA-AEM cell necessitated a cell voltage of 3.3 V to achieve a current density of 500 mA cm⁻². The decrease in FE_{NH3} may be associated with the detrimental effects of the complex interplay between the multi-ionic environment and active sites. On the other hand, the MEA-BPM cell required a cell voltage of 12 V to achieve a current density of 300 mA cm⁻², resulting in a FE_{NH3} of 69% with an NH₃ yield rate of 4.83 mmol cm⁻² h⁻¹. Due to the high cell voltage requirement of the MEA-BPM setup, it is considered undesirable as it entails a significant energy input for efficient NO3RR to NH₃ conversion. While optimization efforts are ongoing to improve the performance of MEA-BPM, the primary focus of this work is to emphasize the membrane role in selectively converting NO₃⁻ to ammonia at high current densities while minimizing cell voltages. Overall, these findings highlight the efficacy of the MEA-AEM approach in achieving high rates for NO3RR to NH₃, showcasing its exceptional potential for treating industrial wastewater with elevated nitrate concentrations.

Additionally, chronopotentiometry conducted on the Cu₁Ru₁₀ catalyst for 100 hours in MEA-AEM setup demonstrated its long-term stability at a high current density of ˜600 mA cm⁻² without significant degradation, highlighting its potential for practical applications. To verify the dynamic evolution of surface structure, XPS analysis was performed after stability test and pulsed electrolysis. The peak position of Ru⁰ and Ru⁴ peaks of Ru 3p XPS spectra shifted to lower binding energies after pulsed electrolysis and stability text compared to the Cu₁Ru₁₀ sample. Additionally, the peak intensity of Ru⁰ decreased while Ru⁴ increased, indicating the formation of RuOx phase. This observation is further supported by the O 1s spectra, which showed peak positions of 530 and 530.9 eV after pulsed electrolysis and stability testing. These peaks are attributed to lattice oxygen, confirming the phase transition during the reaction. The recent results verified that the pulsed electrolysis modulate the local microenvironment and optimize the adsorption energies for reaction intermediates, which in turn enhance the catalytic efficiency of NO3RR under pulsed conditions. In addition, the partial oxidized Ru species have been found to enhance the NO3RR through the direct conversion of NO₃⁻ to NH₃.

TABLE 5
Cathodic reactions and half-cell potentials of studied feedstocks

| | | | |
|---|---|---|---|
| Reduced | | Number of | Half-Cell |
| Species | Cathodic Reaction | Electrons | Potential |

From Wastewater Sources

| | | | | |
|---|---|---|---|---|
| 1 | Nitrate | NO₃⁻ + 8H⁺ + 8e⁻ → NH₃ + 2H₂O + OH⁻ | 8 | 0.7 |
| 2 | Nitrate | NO₂⁻ + 6H⁺ + 6e⁻ → NH₃ + H₂O + OH⁻ | 6 | 0.65 |
| 3 | Dinitrogen Monoxide | ½N₂O + 4H⁺ + 4e⁻ → NH₃ + ½H₂O | 4 | 0.48 |

From Combustion Exhaust

| | | | | |
|---|---|---|---|---|
| 4 | Nitrogen Monoxide | NO + 5H⁺ + 5e⁻ → NH₃ + H₂O | 5 | 0.71 |
| 5 | Nitrogen Dioxide | NO₂ + 7H⁺ + 7e⁻ → NH₃ + 2H₂O | 7 | 0.8 |
| 6 | Dinitrogen Tetroxide | ½N₂O₄ + 7H⁺ + 7e⁻ → NH₃ + 2H₂O | 7 | 0.8 |

From PSA Nitrogen Generator

| | | | | |
|---|---|---|---|---|
| 7 | Nitrogen | ½N₂ + 3H⁺ + 3e⁻ → NH₃ | 3 | 0.58 |

TABLE 6
Total cell voltage approximations for studied
feedstocks - Batch configuration

| | | Cell | Nernstian | Solution | Over- | Total Cell |
|---|---|---|---|---|---|---|
| | Feedstock | Potential | Loss | Loss | potential | Voltage |
| 1 | Nitrate | 0.53 | 0.8 | 0.1 | 0.6 | 2.03 |
| 2 | Nitrate | 0.58 | 0.78 | 0.1 | 0.6 | 2.06 |
| 3 | Dinitrogen | 0.75 | 0.76 | 0.1 | 0.6 | 2.21 |
| | Monoxide | | | | | |
| 4 | Nitrogen | 1.17 | 0.74 | 0.1 | 0.6 | 2.61 |

TABLE 7
Total cell voltage approximations for studied
feedstocks - Flow cell configuration

| | | Cell | Nernstian | Solution | Over- | Total Cell |
|---|---|---|---|---|---|---|
| | Feedstock | Potential | Loss | Loss | potential | Voltage |
| 1 | Nitrate | 0.53 | 0.32 | 0.1 | 0.6 | 1.55 |
| 2 | Nitrate | 0.58 | 0.31 | 0.1 | 0.6 | 1.59 |
| 3 | Dinitrogen | 0.75 | 0.3 | 0.1 | 0.6 | 1.75 |
| | Monoxide | | | | | |
| 4 | Nitrogen | 1.18 | 0.3 | 0.1 | 0.6 | 2.18 |

The main product obtained upon the reduction of nitrate ions is ammonia. Ammonia obtained during electrolysis can be detected and quantified using UV-Vis spectroscopy.

### Electrochemical Characterization of CuRu/CB Catalysts:

The electrochemical NO3RR behavior of CuRu/CB catalysts was estimated using linear sweep voltammetry in Ar saturated 0.1M KOH electrolyte with and without 0.5 M KNO₃. The onset potential shifted to less negative potentials and the current density increased in the presence of 0.5 M KNO₃ in 0.1M KOH electrolyte. This signifies that the catalysts are highly active for electrochemical NO3RR.

### Electrolysis:

The faradaic efficiency of NH₃ increases with increasing Ru concentration. At low applied potentials, CuRu/CB catalyst with 1:10 and 1:100 showed similar faradaic efficiencies. The yield rate of NH₃ is an important descriptor for the efficiency of the catalysts, Though CuRu/CB catalysts with 1:10 and 1:100 ratio show similar faradaic efficiencies, the yield rate is higher with CuRu/CB with 1:100 ratio. At −0.1 V vs RHE, this catalyst produces ˜1400.0 μg of NH₃ per 1.0 g of catalyst used per hour. During one hour of electrolysis with this catalyst, ˜7000.0 μg of NH₃ is produced per unit area of electrode. The higher rate of production of NH₃ with catalyst having Cu:Ru −1:100 may be attributed to the higher current density obtained with this catalyst. A detailed comparison of the three catalysts, indicates that CuRu/CB catalyst with 1:100 ratio shows the highest electrochemical NO3RR performance.

The following identifies proposed apparatus for generating ammonia.

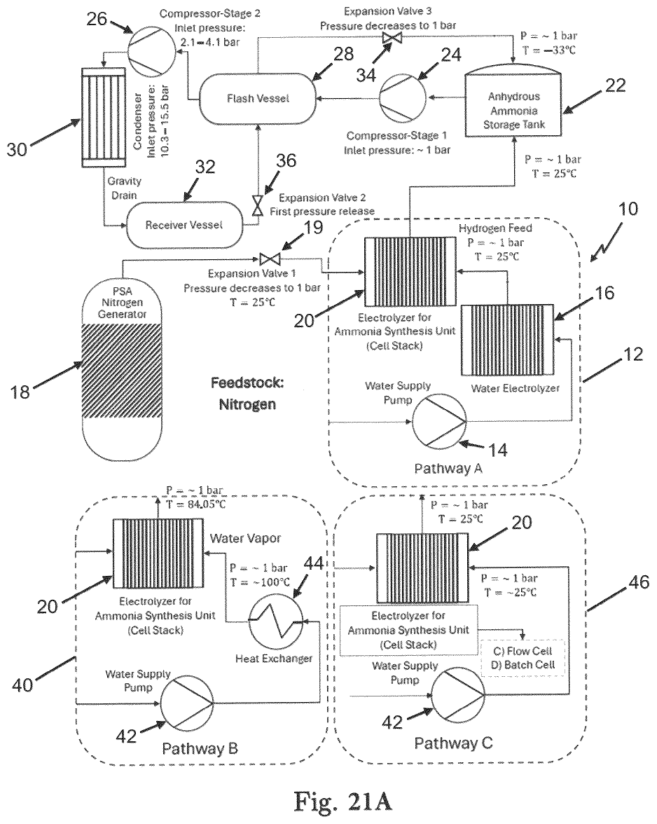

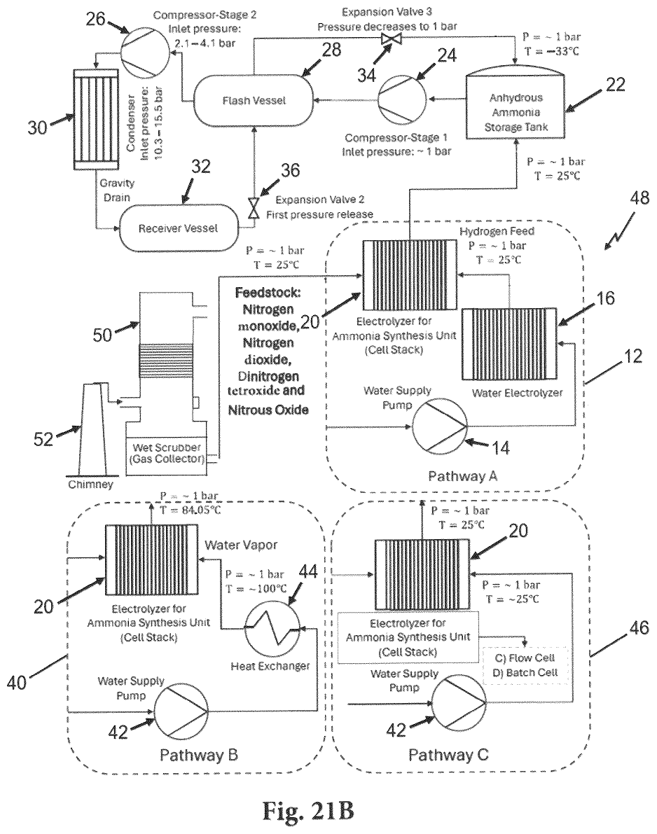

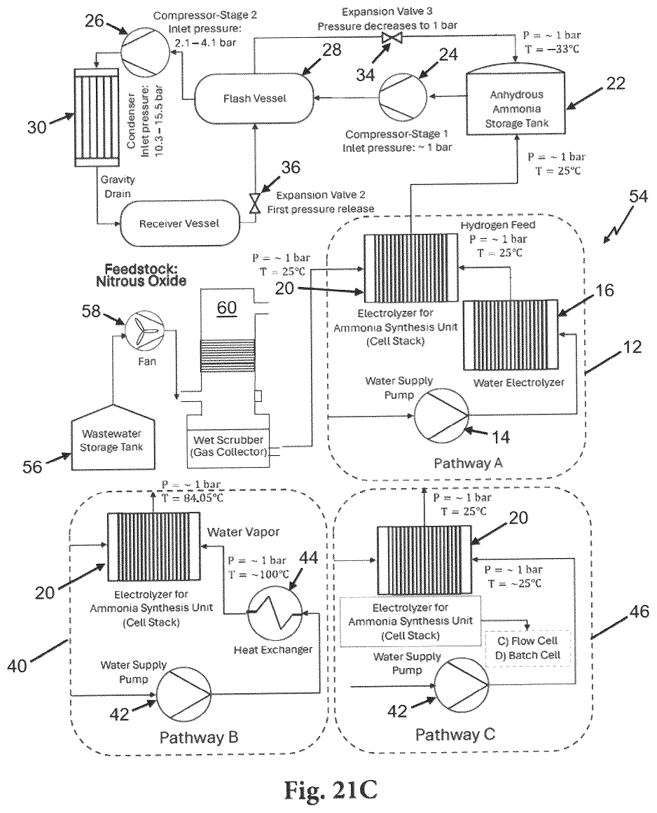

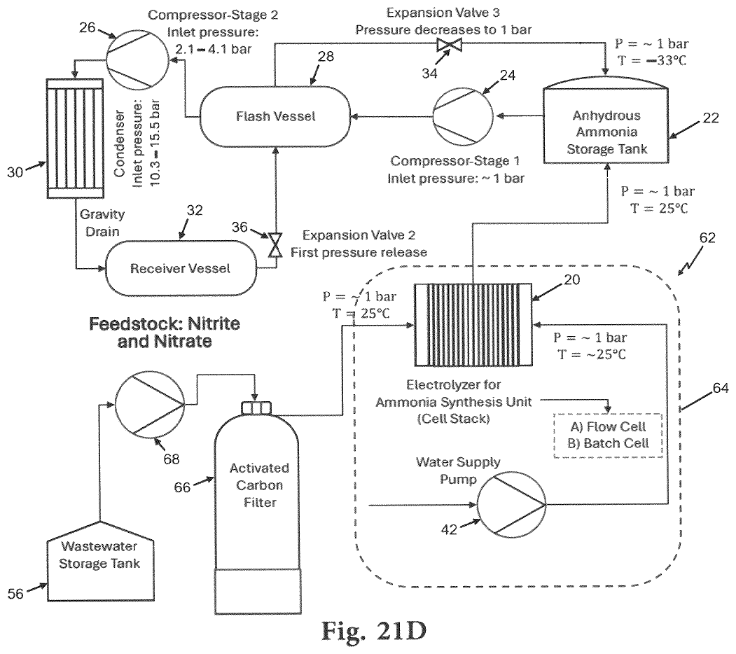

FIG. 21A shows the electrolysis pathway, 10, for generating ammonia using nitrogen feedstock from air. In Pathway A, 12, water, from water supply pump source, 14, is electrolyzed, 16, to generate hydrogen at 1 bar and 25° C., which is mixed with nitrogen from nitrogen source, 18, expanded by valve, 19, to 1 bar at 25° C., and electrolyzed in electrolyzer cell stack, 20, to form ammonia that is collected in storage tank, 22. The ammonia may then be liquefied and refrigerated using a known cooling system including compressors, 24, and 26, flash vessel, 28, condenser, 30, receiver vessel, 32, and expansion valves, 34, and, 36. Nitrogen source 18 may generate nitrogen by pressure swing adsorption (PSA).

In PATHWAY B, 40, water is pumped by water supply pump, 42, through heat exchanger, 44, to generate water vapor at about 100° C. and 1 bar, which is mixed with nitrogen from source 18, electrolyzed in electrolyzer cell stack, 20, to form ammonia that is collected in storage tank, 22.

In PATHWAY C, 46, water is pumped by water supply pump, 42, into the ammonia synthesis unit under ambient conditions, mixed with nitrogen from source 18, electrolyzed in electrolyzer cell stack, 20, in either a flow cell (continuous operation) or batch cell configuration, to form ammonia that is collected in storage tank, 22.

FIG. 21B shows electrolysis pathways, 48, for nitrogen monoxide, nitrogen dioxide, dinitrogen tetroxide, and nitrous oxide feedstocks from exhaust gas collected in aqueous form by wet scrubber, 50, from chimney, 52, and directed into ammonia synthesis Pathways, 12, 40, or 46, where hydrogen from water or water electrolysis is provided as the anode feedstock. Pathways, 12, 40, or 46 (A, B, or C) are similar to those in FIG. 21A, as is the ammonia storage process.

FIG. 21C shows the electrolysis pathways, 54, for nitrous oxide from wastewater storage tank, 56, directed by fan, 58, into wet scrubber, gas collector, 60, after which it is processed in ammonia synthesis pathways, 12, 40, or 46 (A, B, or C). Pathways, 12, 40, or 46 (A, B, or C) are similar to those in FIG. 21A, as is the ammonia storage process. As set forth above, in Pathway A, 12, water is pumped into water electrolyzer 16 by water supply pump 14 and the produced hydrogen enters ammonia synthesis unit 20 at 1 bar and 25° C. as the anode feedstock; in Pathway B, 40, water is pumped into heat exchanger 44 by water supply pump 42 and water vapor enters the ammonia synthesis unit 20 at 1 bar and about 100° C. as the anode feedstock; and in Pathway C, 46, water is pumped by water supply pump 42 at about 1 bar and about 25° C. into the anodic compartment of electrolysis unit 20. The configuration of the ammonia synthesis unit can be batch or flow cells to form ammonia that is collected in storage tank, 22.

FIG. 21D shows the electrolysis pathway, 62, for nitrite and nitrate feedstocks from wastewater storage tank 56, fed into the ammonia synthesis unit, 64, at about 1 bar and 25° C. The nitrite and nitrate feedstocks are pumped into activated carbon filter, 66, by pump, 68, for removal of organics and volatiles. Water at room temperature is directed into ammonia electrolyzer 20 as the anode feedstock. The ammonia synthesis unit is operable under batch or flow conditions (i.e., continuous operation), and the ammonia generated is collected in storage tank 22.

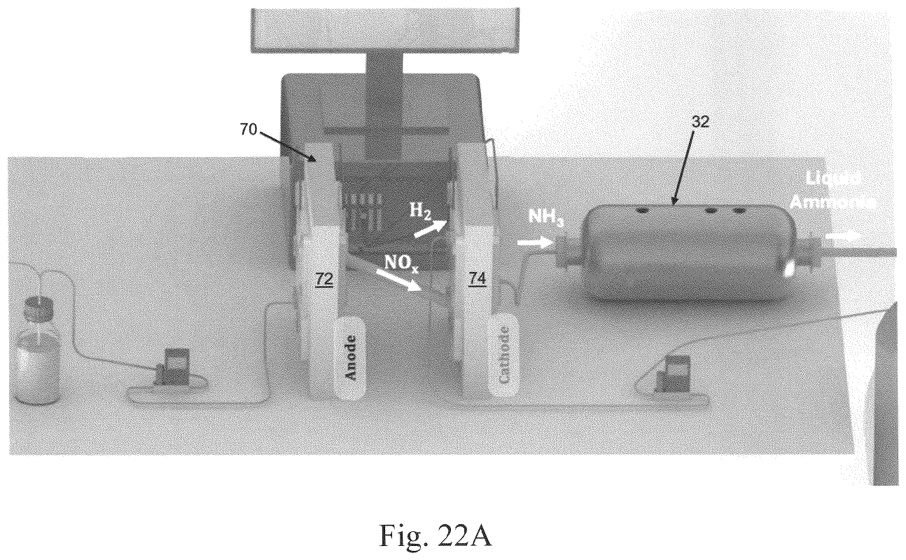

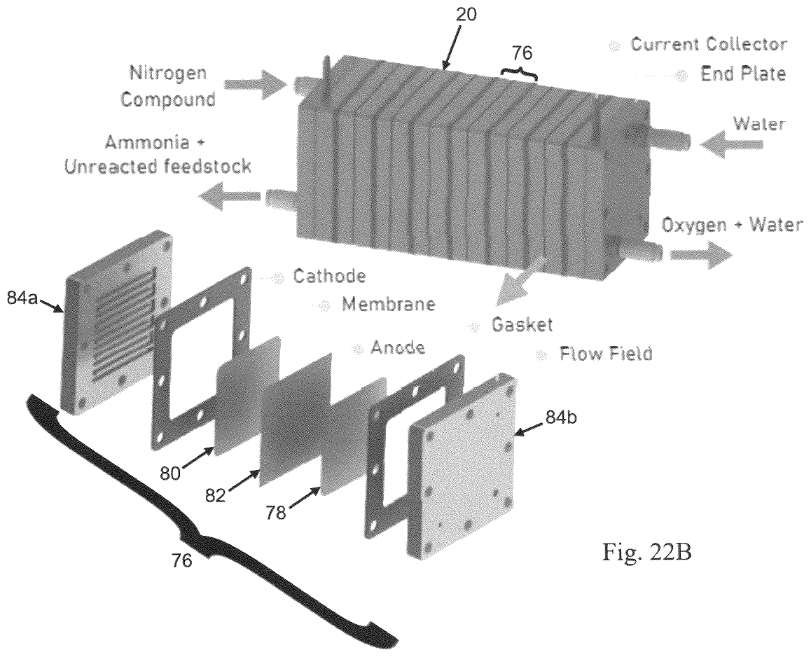

FIG. 22A is a schematic representation of an electrolysis reactor, 70, for producing NH₃ gas from hydrogen and nitrate on cathode, 74, and the collection of liquid ammonia in vessel, 32. A proton-conducting membrane, not shown in FIG. 22A, separates cathode 74 from anode 72.

FIG. 22B shows a schematic representation of stack (electrolyzer unit) 20 and its components for nitrogen-based compound transformation to ammonia. Each cell, 76, of stack 20 includes anode, 78, cathode, 80, proton-conducting membrane, 82, and end caps, 84a, and 84b. Water or water vapor is oxidized to oxygen gas and H⁺ at anode, 78. If hydrogen gas is used for the anodic reaction, H⁺ is the only product. The cathodic, 80, reaction involves reducing nitrogen compounds to ammonia.

What is claimed is:

1. An apparatus for producing ammonia by electrochemical reduction of nitrates or nitrites, comprising:
a source of hydrogen or water;
a source of nitrates or nitrites;
a first electrolyzer comprising a first compartment for receiving nitrates or nitrites from said source of nitrates or nitrites in a basic aqueous electrolyte, comprising a cathode as a working electrode, said cathode comprising a catalyst comprising at least two transition metals for reducing nitrates from said source of nitrates or nitrites, and hydrogenating the reduced nitrates to form ammonia, and a reference electrode, a second compartment for receiving hydrogen or water from said source of hydrogen or water, comprising an anode;
a proton-conducting membrane for separating said first compartment and said second compartment; and
a source of electrical potential for providing electrical power to said cathode and said anode, and an anion exchange membrane.

2. The apparatus of claim 1, further comprising a second electrolyzer for electrolyzing water from said source of water to generate hydrogen.

3. The apparatus of claim 1, wherein said source of electrical potential is a pulsed source of electrical potential.

4. The apparatus of claim 1, wherein said catalyst comprises a CuₓRu_{y} alloy.

5. The apparatus of claim 4, wherein the mole ratios of Cu to Ru (x:y) are chosen from 100:1; 10:1; 1:1; 1:10; and 1:100.

6. The apparatus of claim 4, wherein x and y are non-integers.

7. The apparatus of claim 4, wherein said CuₓRu_{y} alloy catalyst comprises a dispersion of CuₓRu_{y} nanoparticles supported by carbon nanostructures.

8. The apparatus of claim 7, wherein said carbon nanostructures comprise carbon black.

9. The apparatus of claim 8, wherein the combined ratio of Cu and Ru to carbon black is 1:100 or 5:100.

10. The apparatus of claim 1, further comprising an activated carbon filter for removal of organics and volatiles from said nitrates and nitrites.

11. The apparatus of claim 1, wherein said first electrolysis apparatus comprises an H-cell or membrane-electrode assembly (MEA) configuration.

12. The apparatus of claim 1, wherein said first compartment is flushed using argon.

13. The apparatus of claim 1, wherein said apparatus is operable under batch or flow conditions.

14. The apparatus of claim 1, further comprising a storage tank for collecting said produced ammonia.

15. The apparatus of claim 1, wherein said first compartment and said second compartment have a pressure between 1 and 10 bar.

16. The apparatus of claim 1, wherein said first compartment and said second compartment have a temperature between 10° C. and 100° C.

17. An apparatus for producing ammonia by electrochemical reduction of gaseous NOₓ, N₂, N₂O, or combinations thereof, comprising:
a source of hydrogen or water;
a source of NOₓ, N₂, N₂O, or combinations thereof;
a gas phase electrolyzer comprising a first compartment for receiving NOₓ, N₂, N₂O, or combinations thereof from said source of NOₓ, N₂, N₂O, or combinations thereof, comprising a cathode as a working electrode, said cathode comprising a catalyst comprising a porous bimetallic Pd—Ag or Pd—Cu nanoparticle catalyst, and a reference electrode, and a second compartment comprising an anode comprising Pt nanoparticles for receiving hydrogen or water from said source of hydrogen or water and for flowing a portion of the hydrogen or water into said first compartment;
a proton-conducting membrane for separating said first compartment from said second compartment; and
a source of electrical potential for providing electrical power to said cathode and said anode.

18. The apparatus of claim 17, wherein said Pd—Ag and Pd—Cu nanoparticles are synthesized by galvanic displacement and incipient wetness co-impregnation (IWI) method.

19. The apparatus of claim 17, wherein said Pd—Ag and Pd—Cu nanoparticles are supported by carbon nanostructures.

20. The apparatus of claim 19, wherein said carbon nanostructures comprise carbon black.

21. The apparatus of claim 17, wherein the ratio of Pd to Cu is 100; 3:1; 1:1; 1:3; or 1:100.

22. The apparatus of claim 17, wherein said source of electrical potential comprises a pulsed source of electrical potential.

23. The apparatus of claim 17, wherein said NOₓ comprises NO2 or NO.

24. The apparatus of claim 17, wherein said first compartment and said second compartment have a pressure between 1 and 10 bar.

25. The apparatus of claim 17, wherein said first compartment and said second compartment have a temperature between 10° C. and 100° C.

26. The apparatus of claim 17, further comprising a water electrolyzer for generating hydrogen.

27. The apparatus of claim 17, wherein in said source of nitrogen is generated by pressure swing adsorption.
